(19) United States
(12) Patent Application Publication
(10) Pub. No.: US 2023/0312797 A1
(43) Pub. Date: Oct. 5, 2023

(54) VISCOSITY INDEX IMPROVING AGENT AND LUBRICATING OIL COMPOSITION

(71) Applicant: SANYO CHEMICAL INDUSTRIES, LTD., Kyoto (JP)

(72) Inventors: Nobuhiro NAITO, Kyoto (JP); Satoshi MATSUMOTO, Kyoto (JP); Masahiro HASHIMOTO, Kyoto (JP); Kenyuu YOSHIDA, Kyoto (JP); Hiroki YAMASHITA, Kyoto (JP); Ryota SATO, Kyoto (JP)

(73) Assignee: SANYO CHEMICAL INDUSTRIES, LTD., Kyoto (JP)

(21) Appl. No.: 18/025,238

(22) PCT Filed: Sep. 14, 2021
(86) PCT No.: PCT/JP2021/033640

§ 371 Date: Mar. 8, 2023

(30) Foreign Application Priority Data
Sep. 14, 2020 (JP) 2020-154045

(51) Int. Cl. C08F 279/02; C08K 5/101; C08K 5/01

(52) U.S. Cl. CPC C08F 279/02; C08K 5/101; C08K 5/01

(57) ABSTRACT

The present invention aims to provide a viscosity-index improving agent capable of providing a lubricating oil composition having an appropriate gelation index, an excellent HTHS viscosity at 100° C., and an excellent kinematic viscosity at 40° C. when the viscosity-index improving agent is added thereto. The present also aims to provide a lubricating oil composition containing the viscosity-index improving agent. The present invention relates to, for example, a viscosity-index improving agent containing a copolymer (A) and an ester oil (Z), the copolymer A containing, as constituent monomers, a polyolefin-based monomer (a) represented by the following formula (1), a monomer (b) represented by the following formula (2) in which R⁴ is a C4 alkyl group, and at least one of a monomer (c) represented by the following formula (3) and a monomer (d) represented by the following formula (2) in which R⁴ is a C2-C3 alkyl group:

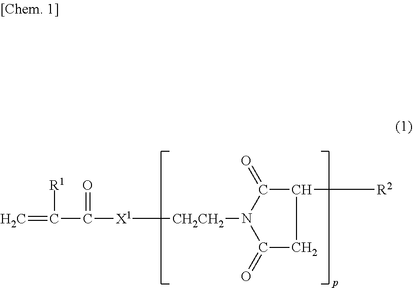

wherein R¹ is a hydrogen atom or a methyl group; —X¹— is a group represented by —O—, —O(AO)ₘ—, or —NH—, A is a C2-C4 alkylene group, m is an integer of 1 to 10, and each A may be the same or different when m is 2 or more; R² is a residue after removal of one hydrogen atom from a hydrocarbon polymer containing a 1,2-butylene group as a structural unit; and p represents a number of 0 or 1;

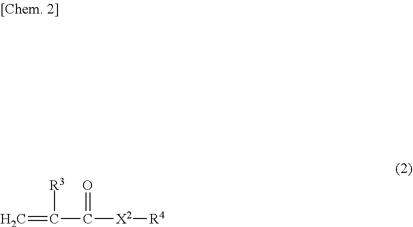

wherein R³ is a hydrogen atom or a methyl group; —X²— is a group represented by —O— or —NH—; and R⁴ is a C2-C4 alkyl group;

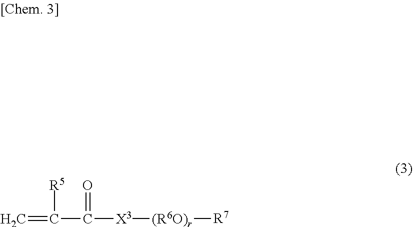

wherein R⁵ is a hydrogen atom or a methyl group; —X³— is a group represented by —O— or —NH—; R⁶ is a C2-C4 alkylene group; R⁷ is a C1-C8 alkyl group; and r is an integer of 1 to 20, and each R⁶ may be the same or different when r is 2 or more.

### TECHNICAL FIELD

The present invention relates to a viscosity-index improving agent and a lubricating oil composition.

### BACKGROUND ART

Nowadays, there is an increasing demand for lower fuel consumption of vehicles in order to reduce the amount of CO₂ emission and protect petroleum resources. One approach to reduce the fuel consumption is a reduction in viscous resistance of an engine oil by lowering its viscosity. However, a lower viscosity causes problems such as oil leakage and seizure. Regarding these problems, the standard for engine oil viscosity (SAE J300) by SAE International (USA) specifies the minimum guaranteed viscosity and defines grade 0W-20 oil as having a high temperature high shear (HTHS) viscosity at 150° C. (ASTM D4683 or D5481) of 2.6 mPa-s or more. Grade 0W-16 oil is defined as having a HTHS viscosity at 150° C. of 2.3 mPa-s or more. In addition, for the same grade oil, the low-temperature viscosity which is referred to as gelation index is specified to 12 or less in order to ensure the startability in cold regions. When the gelation index is high, gelation of engine oil easily occurs at low temperatures, leading to poor engine startability. To lower the fuel consumption, there is a demand for an engine oil that satisfies the above standard and that also has an even lower HTHS viscosity at an effective temperature of 100° C. and an even lower kinematic viscosity in the low temperature region, particularly at 40° C. Known examples of such a viscosity-index improving agent include methacrylate ester copolymers (Patent Literatures 1 to 4), an olefin copolymer (Patent Literature 5), and comb copolymers (Patent Literatures 6 to 8).

However, these viscosity-index improving agents are still insufficient in terms of HTHS viscosity at 100° C. when added to an engine oil composition and have an undesirable kinematic viscosity at 40° C.

### CITATION LIST

### Patent Literature

Patent Literature 1: JP 6060311 B
Patent Literature 2: JP 2732187 B
Patent Literature 3: JP 2754343 B
Patent Literature 4: JP 3831203 B
Patent Literature 5: JP 3999307 B
Patent Literature 6: JP 3474918 B
Patent Literature 7: JP 2008-546894 A
Patent Literature 8: JP 2010-532805 A

### SUMMARY OF INVENTION

### Technical Problem

The present invention aims to provide a viscosity-index improving agent capable of providing a lubricating oil composition having an appropriate gelation index, an excellent HTHS viscosity at 100° C., and an excellent kinematic viscosity at 40° C. when the viscosity-index improving agent is added thereto. The present invention also aims to provide a lubricating oil composition containing the viscosity-index improving agent.

### Solution to Problem

As a result of extensive studies, the present inventors completed the present invention.

Specifically, the present invention provides a viscosity-index improving agent containing a copolymer (A) and an ester oil (Z), the copolymer A containing, as constituent monomers, a polyolefin-based monomer (a) represented by the following formula (1), a monomer (b) represented by the following formula (2) in which R⁴ is a C4 alkyl group, and at least one of a monomer (c) represented by the following formula (3) and a monomer (d) represented by the following formula (2) in which R⁴ is a C2-C3 alkyl group; and a lubricating oil composition containing the viscosity-index improving agent and at least one additive selected from the group consisting of a detergent, a dispersant, an antioxidant, an oiliness improver, a pour point depressant, a friction and wear modifier, an extreme pressure agent, a defoamer, a demulsifier, a metal deactivator, and a corrosion inhibitor:

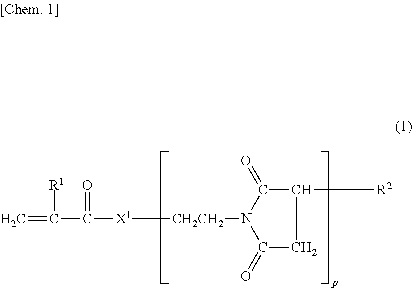

wherein R¹ is a hydrogen atom or a methyl group; —X¹— is a group represented by —O—, —O(AO)ₘ—, or —NH—, A is a C2-C4 alkylene group, m is an integer of 1 to 10, and each A may be the same or different when m is 2 or more; R² is a residue after removal of one hydrogen atom from a hydrocarbon polymer containing a 1,2-butylene group as a structural unit; and p represents a number of 0 or 1;

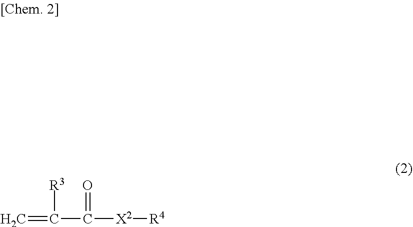

wherein R³ is a hydrogen atom or a methyl group; —X²— is a group represented by —O— or —NH—; and R⁴ is a C2-C4 alkyl group;

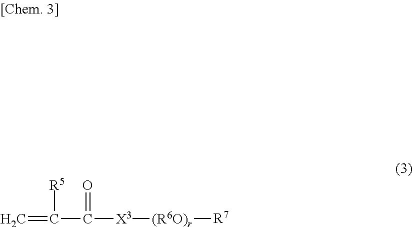

wherein R⁵ is a hydrogen atom or a methyl group; —X³— is a group represented by —O— or —NH—; R⁶ is a C2-C4 alkylene group; R⁷ is a C1-C8 alkyl group; and r is an integer of 1 to 20, and each R⁶ may be the same or different when r is 2 or more.

### Advantageous Effects of Invention

The lubricating oil composition containing the viscosity-index improving agent of the present invention advantageously has an appropriate gelation index, a low HTHS viscosity at 100° C., and a low kinematic viscosity at 40° C.

### DESCRIPTION OF EMBODIMENTS

The viscosity-index improving agent of the present invention contains a copolymer (A) and an ester oil (Z), the copolymer (A) containing, as constituent monomers, a polyolefin-based monomer (a) represented by the following formula (1), a monomer (b) represented by the following formula (2) in which R⁴ is a C4 alkyl group, and at least one of a monomer (c) represented by the following formula (3) and a monomer (d) represented by the following formula (2) in which R⁴ is a C2-C3 alkyl group:

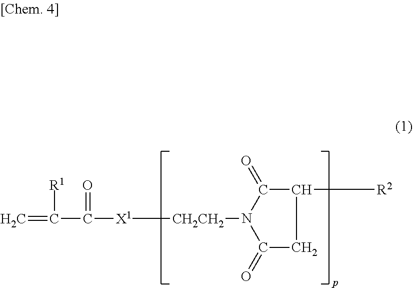

wherein R¹ is a hydrogen atom or a methyl group; —X¹— is a group represented by —O—, —O(AO)ₘ—, or —NH—, A is a C2-C4 alkylene group, m is an integer of 1 to 10, and each A may be the same or different when m is 2 or more; R² is a residue after removal of one hydrogen atom from a hydrocarbon polymer containing a 1,2-butylene group as a structural unit; and p represents a number of 0 or 1;

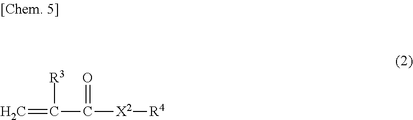

wherein R³ is a hydrogen atom or a methyl group; —X²— is a group represented by —O— or —NH—; and R⁴ is a C2-C4 alkyl group;

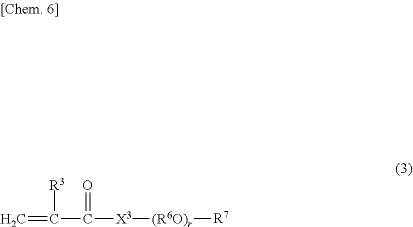

wherein R⁵ is a hydrogen atom or a methyl group; —X³— is a group represented by —O— or —NH—; R⁶ is a C2-C4 alkylene group; R⁷ is a C1-C8 alkyl group; and r is an integer of 1 to 20, and each R⁶ may be the same or different when r is 2 or more.

### <Copolymer (A)>

The viscosity-index improving agent of the present invention contains a copolymer (A) containing, as constituent monomers, a polyolefin-based monomer (a) represented by the formula (1), a monomer (b) represented by the formula (2) in which R⁴ is a C4 alkyl group, and at least one of a monomer (c) represented by the formula (3) and a monomer (d) represented by the formula (2) in which R⁴ is a C2-C3 alkyl group. The monomers (a) to (d) may each include one or more monomers (a) to (d), respectively.

The polyolefin-based monomer (a) represented by the formula (1) is now described.

R¹ in the formula (1) is a hydrogen atom or a methyl group. Of these, a methyl group is preferred in terms of viscosity index improving effect.

—X¹— in the formula (1) is a group represented by —O—, —O(AO)ₘ—, or —NH—.

A is a C2-C4 alkylene group. Examples include ethylene, 1,2- or 1,3-propylene, isobutylene, and 1,2-, 1,3- or 1,4-butylene groups.

AO is a C2-C4 alkyleneoxy group. Examples include ethyleneoxy, 1,2- or 1,3-propyleneoxy, isobutyleneoxy, and 1,2-, 1,3- or 1,4-butyleneoxy groups.

m is the number of moles of an alkylene oxide added, and it is an integer of 1 to 10. In terms of viscosity index improving effect, it is preferably an integer of 1 to 4, more preferably 1 or 2.

Each A may be the same or different when m is 2 or more, and each AO in the (AO)ₘ moiety may be bonded in a random form or a block form.

In terms of viscosity index improving effect, —X¹— is preferably a group represented by —O— or —O(AO)ₘ—, more preferably a group represented by —O— or —O(CH₂CH₂O)₁—.

p represents a number of 0 or 1.

R² in the formula (1) is a residue after removal of one hydrogen atom from a hydrocarbon polymer containing a 1,2-butylene group (—CH₂CH(CH₂CH₃)— or CH(CH₂CH₃)CH₂—) as a structural unit.

In the hydrocarbon polymer containing a 1,2-butylene group as a structural unit, the proportion of the 1,2-butylene group in the total structural units is preferably 10 to 90 mol %, more preferably 20 to 80 mol %, in terms of HTHS viscosity at 100° C.

When the hydrocarbon polymer containing a 1,2-butylene group as a structural unit contains two hydrocarbon polymers with different proportions of 1,2-butylene groups, the absolute difference in proportion between the two 1,2-butylene groups is preferably 10 to 80 mol %, more preferably 20 to 70 mol %, in terms of low-temperature viscosity.

The hydrocarbon polymer containing a 1,2-butylene group as a structural unit is preferably one having a carbon number of 37 or more. Examples include a polymer containing 1-butene as a constituent monomer (unsaturated hydrocarbon (x)) and a polymer obtained by hydrogenating a carbon-carbon double bond of a 1,2-adduct polymer of 1,3-butadiene.

Regarding the structure derived from 1-butene and/or 1,3-butadiene in the hydrocarbon polymer in the formula (1), the proportion of the 1,2-butylene group in the total structural units can be measured by ¹³C-NMR. Specifically, for example, when the monomers include only those having a carbon number of 4, the proportion can be determined by analyzing the hydrocarbon polymer by ¹³C-NMR and calculating by the following formula (1). In ¹³C-NMR, a peak derived from the tertiary carbon atom of a branched methylene group (—CH₂CH(CH₂CH₃)—) of the 1,2-butylene group appears at an integral value of 26 to 27 ppm (integral value B). The proportion of the 1,2-butylene group can be determined from the integral value of the peak and an integral value (integral value C) of all carbon peaks of the hydrocarbon polymer.

Proportion of 1,2-butylene group (mol %)={(integral value B)×4}/(integral value C)×100 (1)

The proportion of the 1,2-butylene group can be adjusted as follows: for example, in the case of anionic polymerization using 1,3-butadiene, the proportion of the 1,2-butylene group can be increased by setting the reaction temperature to a temperature lower than or equal to the boiling point (−4.4° C.) of 1,3-butadiene and adding a polymerization initiator in an amount smaller than that of 1,3-butadiene, whereas the proportion of the 1,2-butylene group can be decreased by setting the reaction temperature to a temperature higher than or equal to the boiling point of 1,3-butadiene and adding a polymerization initiator in an amount larger than that of 1,3-butadiene.

In terms of viscosity index improving effect, the proportion of 1,3-butadiene of all monomers constituting R² in the formula (1) (weight percentage of 1,3-butadiene among all constituent monomers of the hydrocarbon polymer containing a 1,2-butylene group as a structural unit) is preferably 50 wt % or more, more preferably 75 wt % or more, particularly preferably 85 wt % or more, most preferably 90 wt % or more.

In the structure derived from 1,3-butadiene constituting a portion or the entirety of R² in the formula (1), the molar ratio (1,2-adduct/1,4-adduct) of a 1,2-butylene group (1,2-adduct) to a 1,4-butylene group (1,4-adduct) is preferably 1/99 to 99/1, more preferably 10/90 to 90/10, particularly preferably 20/80 to 80/20, in terms of viscosity index improving effect and low-temperature viscosity.

Preferably, the monomer (a) includes one having a molar ratio (1,2-adduct/1,4-adduct) of 1/99 to 50/50 and one having a molar ratio (1,2-adduct/1,4-adduct) of 51/49 to 99/1. More preferably, the monomer (a) includes one having a molar ratio (1,2-adduct/1,4-adduct) of 10/90 to 50/50 and one having a molar ratio (1,2-adduct/1,4-adduct) of 55/45 to 90/10.

The molar ratio of a 1,2-adduct to a 1,4-adduct in the structure derived from 1,3-butadiene constituting a part or the entirety of R² in the formula (1) can be measured by ¹H-NMR, ¹³C-NMR, Raman spectroscopy, or the like.

In terms of low-temperature viscosity, R² in the formula (1) is preferably a residue after removal of one hydrogen atom from a hydrocarbon polymer containing a 1,2-butylene group and an isobutylene group as structural units. A hydrocarbon polymer containing an isobutylene group as a structural unit can be obtained by a method using isobutene as a constituent monomer (unsaturated hydrocarbon (x)), for example.

In terms of low-temperature viscosity, the total proportion of the isobutylene group and the 1,2-butylene group in the hydrocarbon polymer based on the total number of moles of the structural units of the hydrocarbon polymer is preferably 30 mol % or more, more preferably 40 mol % or more, particularly preferably 50 mol % or more, most preferably 60 mol % or more.

The total proportion of the isobutylene group and the 1,2-butylene group based on the total number of structural units of the hydrocarbon polymer can be determined by analyzing the hydrocarbon polymer by ¹³C-nuclear magnetic resonance spectrum and calculating by the following formula (2). Specifically, for example, when the monomers include only those having a carbon number of 4, a ¹³C-nuclear magnetic resonance spectrum shows a peak derived from a methyl group of the isobutylene group at an integral value of 30 to 32 ppm (integral value A) and a peak derived from the tertiary carbon atom of a branched methylene group of the 1,2-butylene group at an integral value of 26 to 27 ppm (integral value B). The total proportion can be determined from the integral value of the peak and an integral value (integral value C) of all carbon peaks of the hydrocarbon polymer.

Total proportion (mol %) of isobutylene group and 1,2-butylene group={(integral value A)×2+(integral value B)×4}/(integral value C)×100 (2)

The hydrocarbon polymer containing a 1,2-butylene group as a structural unit may contain, as constituent monomers, the following monomers (1) to (3) as the unsaturated hydrocarbons (x) in addition to 1-butene and 1,3-butadiene.

(1) Aliphatic unsaturated hydrocarbon (e.g., C2-C36 olefins (e.g., ethylene, propylene, 2-butene, isobutene, pentene, heptene, diisobutylene, octene, dodecene, octadecene, triacontene, and hexatriacontene) and C4-C36 dienes (e.g., isoprene, 1,4-pentadiene, 1,5-hexadiene, and 1,7-octadiene))

(2) Alicyclic unsaturated hydrocarbon (e.g., cyclohexene, (di)cyclopentadiene, pinene, limonene, indene, vinylcyclohexene, and ethylidenebicycloheptene)

(3) Aromatic group-containing unsaturated hydrocarbon (e.g., styrene, α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, vinylnaphthalene, divinylbenzene, divinyltoluene, divinylxylene, and trivinylbenzene).

A hydrocarbon polymer composed of any of these monomers may be a block polymer or a random polymer. When the hydrocarbon polymer has a carbon-carbon double bond, the double bond may be partially or completely hydrogenated by adding hydrogen. In one embodiment, the hydrocarbon polymer in R² may be a hydrocarbon polymer containing only a C4 monomer as a constituent monomer, and the C4 monomer may be 1-butene and/or 1,3-butadiene and may contain isobutene, if necessary.

The weight percentage of unsaturated hydrocarbons other than 1-butene, 1,3-butadiene, and isobutene in the monomer (a) is preferably 50 wt % or less, more preferably 25 wt % or less, still more preferably 15 wt % or less, particularly preferably 10 wt % or less.

The weight average molecular weight (hereinafter abbreviated as Mw) and the number average molecular weight (hereinafter abbreviated as Mn) of the monomer (a) can be measured by gel permeation chromatography (hereinafter abbreviated as GPC) under the following conditions.

<Measuring Conditions for Mw and Mn of Monomer (a)>Device: “HLC-8320GPC” (available from Tosoh Corporation) Column: “TSKgel GMHXL” (available from Tosoh Corporation) two columns “TSKgel Multipore HXL-M” (available from Tosoh Corporation) one column Measurement temperature: 40° C.

Sample solution: 0.25 wt % tetrahydrofuran solution Volume of solution injected: 10.0 μl Detecting device: refractive index detector Reference material: standard polystyrene (TS reference material: standard polystyrene (TSKstandard POLYSTYRENE) 12 samples (molecular weight: 589, 1,050, 2,630, 9,100, 19,500, 37,900, 96,400, 190,000, 355,000, 1,090,000, 2,110,000, 4,480,000) (available from Tosoh Corporation)

The Mn of the monomer (a) is preferably 800 to 10,000, more preferably 1,000 to 9,000, still more preferably 1,200 to 8,500.

When the monomer (a) has a Mn of 800 or more, the viscosity index improving effect tends to be good. When the monomer (a) has a Mn of 10,000 or less, the shear stability tends to be good for long time use.

In terms of low-temperature viscosity, the Mw of the monomer (a) is preferably 900 to 13,000, more preferably 1,200 to 12,000, particularly preferably 1,500 to 11,000.

The monomer (a) can be obtained by esterification of a polymer (Y) having a hydroxy group at one end obtained by introducing a hydroxy group to one end of a hydrocarbon polymer with (meth)acrylic acid or can be obtained by transesterification of the polymer (Y) with a (meth)acrylic alkyl (preferably C1-C4 alkyl) ester such as methyl (meth)acrylate, for example.

The “(meth)acrylic acid” refers to acrylic acid and/or methacrylic acid.

In terms of solubility in the lubricating oil, the solubility parameter (hereinafter abbreviated as SP) of a structural unit derived from the monomer (a) (a structure in which vinyl group moieties of the monomer (a) are reacted to form a single bond) is preferably 7.0 to 9.0 (cal/cm³)^{1/2}, more preferably 7.3 to 8.5 (cal/cm³)^{1/2}. The SP in the present invention is a value calculated according to the method described in Fedors method (Polymer Engineering and Science, February 1974, Vol. 14, No. 2, pp. 147 to 154) by substituting values (heat of vaporization and molar volume of atoms or functional groups at 25° C.) described on page 153 (Table 5) into formula (28) on page 153 of the same journal. Specifically, the SP can be calculated by substituting numerical values corresponding to the types of atoms and atomic groups in the molecular structure among the numerical values of Δeᵢ and Δvᵢ (Fedors's parameters) described in the following Table 1 into the following formula.

SP=(ΣΔeᵢΣΔvᵢ)^{1/2}

TABLE 1

| | [symbol] | [symbol] |
|---|---|---|
| Atom or group | cal/mole | cm³/mole |
| CH [symbol] | 1125 | 33.5 |
| CH [symbol] | 1180 | 16.1 |
| CH | 820 | −1.0 |
| C | 350 | −19.2 |
| H₂C═ | 1030 | 28.5 |
| —CH═ | 1030 | 13.5 |
| C═ | 1030 | −5.5 |
| HC═ | 920 | 27.4 |
| —C═ | 1690 | 6.5 |
| Phenyl* | 7630 | 71.4 |
| Phenylene (o, m, p)* | 7630 | 52.4 |
| Prenyt (trisubstituted)* | 7630 | 33.4 |
| Phenyl (tetrasubstituted)* | 7630 | 14.4 |
| Phenyl (pentasubstituted)* | 7630 | −4.6 |
| Phenyl (hexasubstituted)* | 7630 | −23.6 |
| Ring closure 5 or more atoms | 250 | 16 |
| Ring closure 3 or 4 atoms | 750 | 18 |
| Conjugation in ring for each double bond | 400 | −2.2 |
| Halogen attached to carbon | −20 percent of | 4.0 |
| atom with double bond | S [symbol] of halogen | |
| CO₂ (carbonate) | 4700 | 22.0 |
| COOH | 6600 | 28.5 |
| CO₂ | 4300 | 18.0 |
| CO | 4150 | 10.8 |
| CHO (aldehyde) | 5100 | 22.3 |
| CO₂CO [symbol] (oxalate) | 6100 | 37.3 |
| C₂O [symbol] (anhydride) | 7300 | 30.0 |
| HCOO (formate) | 4300 | 32.5 |
| CONH [symbol] | 10000 | 17.5 |
| CONH | 8000 | 9.5 |
| CON | 7050 | −7.7 |
| HCON | 6800 | 11.3 |
| HCONH | 10500 | 27.0 |
| COCl | 5000 | 38.0 |
| NH [symbol] | 3000 | 19.2 |
| NH | 2000 | 4.5 |
| N | 1000 | −9.0 |
| —N═ | 2800 | 5.0 |
| CN | 6100 | 24.0 |
| NO₂ (aliphatic) | 7000 | 24.0 |
| NO [symbol] (aromatic) | 3570 | 32.0 |
| NO [symbol] | 5000 | 33.5 |
| NO [symbol] (nitrite) | 2800 | 33.5 |
| SCN | 4800 | 37.0 |
| NCO | 6800 | 35.0 |
| NF [symbol] | 1830 | 33.1 |
| NF | 1210 | 24.5 |
| O | 800 | 3.8 |
| OH | 7120 | 10.0 |
| OH (disubstituted or on adjacent C atoms) | 5220 | 13.0 |
| PO [symbol] | 5000 | 28.0 |
| PO [symbol] | 3400 | 22.7 |
| SH | 3450 | 28.3 |
| S | 3380 | 12 |
| S [symbol] | 5700 | 23.0 |
| SO [symbol] | 4500 | 27.6 |
| SO [symbol] | 6800 | 31.6 |
| F | 1000 | 18.0 |
| F (disubstituted) | 850 | 20.0 |
| F (trisubstituted) | 550 | 22.0 |
| CF [symbol] (for perfluoro compounds) | 1020 | 23.0 |
| CF [symbol] (for perfluoro compounds) | 1020 | 57.5 |
| Cl | 2760 | 24.0 |
| Cl (disubstituted) | 2300 | 26.0 |
| Cl (trisubstituted) | 1800 | 27.3 |
| Br | 3700 | 30.0 |
| Br (disubstituted) | 2950 | 31.0 |
| Br (trisubstituted) | 2550 | 32.4 |
| I | 4550 | 31.5 |
| I (disubstituted) | 4000 | 33.3 |
| I (trisubstituted) | 3900 | 37.0 |
| B | 3300 | −2.0 |
| Al | 3300 | −2.0 |
| Ga | 3300 | −2.0 |
| In | 3300 | −2.0 |
| Tl | 3300 | −2.0 |
| Si | 810 | 0 |
| Ga | 1930 | −1.5 |
| Sn | 2700 | 1.5 |
| Pb | 4100 | 2.5 |
| P | 2250 | −1.0 |
| As | 3100 | 7.0 |
| Sb | 3900 | 8.9 |
| Bi | 5100 | 9.5 |
| S [symbol] | 4100 | 16.0 |
| Te | 4600 | 17.4 |
| Zn | 3460 | 2.5 |
| Cd | 4250 | 6.5 |
| Hg | 5450 | 7.5 |

[symbol]

indicates data missing or illegible when filed

The SP of the structural unit derived from the monomer (a) can be calculated using the parameters described above based on the molecular structure of the structural unit derived from the monomer (a). The SP can be adjusted to a desired range by suitably adjusting the monomers (unsaturated hydrocarbons (x)) for use and the weight fractions of the monomers.

Specific examples of the polymer (Y) having a hydroxy group at one end include the following (Y1) to (Y4).

Alkylene oxide adduct (Y1): Examples include a product obtained by adding an alkylene oxide (e.g., ethylene oxide or propylene oxide) to a polymer obtained by polymerizing the unsaturated hydrocarbon (x) in the presence of an ionic polymerization catalyst (e.g., lithium catalyst and sodium catalyst) (e.g., one represented by the formula (1) in which —X¹— is —(AO)ₘ— and p is 0).

Hydroborated product (Y2): Examples include a reaction product obtained by hydroboration of a polymer of the unsaturated hydrocarbon (x) having a double bond at one end (e.g., the one disclosed in U.S. Pat. No. 4,316,973) (e.g., one represented by the formula (1) in which —X¹— is —O— and p is 0).

Maleic anhydride-ene-amino alcohol adduct (Y3): Examples include a product obtained by amino alcohol-mediated imidization of a reaction product obtained by an ene reaction of a polymer of the unsaturated hydrocarbon (x) having a double bond at one end with maleic anhydride (e.g., one represented by the formula (1) in which —X¹— is —O— and p is 1).

Hydroformylated-hydrogenated product (Y4): Examples include a product obtained by hydroformylation of a polymer of the unsaturated hydrocarbon (x) having a double bond at one end, followed by hydrogenation (e.g., the one disclosed in JP S63-175096 A) (e.g., one represented by the formula (1) in which —X¹— is —O— and p is 0).

In terms of HTHS viscosity and viscosity index improving effect, the polymer (Y) having a hydroxy group at one end is preferably the alkylene oxide adduct (Y1), the hydroborated product (Y2), or the maleic anhydride-ene-amino alcohol adduct (Y3), more preferably the alkylene oxide adduct (Y1).

The monomer (b) represented by the formula (2) is now described.

In the monomer (b), R³ in the formula (2) is a hydrogen atom or a methyl group. Of these, a methyl group is preferred in terms of viscosity index improving effect.

The monomer (b) is a monomer represented by the formula (2) in which R⁴ is a C4 alkyl group.

Examples of the C4 alkyl group include n-butyl, isobutyl, s-butyl, and t-butyl groups.

Specific examples of the monomer (b) include butyl (meth)acrylates (e.g., n-butyl (meth)acrylate and isobutyl (meth)acrylate) and N-butyl (meth)acrylamide.

In terms of viscosity index improving effect, the monomer (b) is preferably butyl (meth)acrylate, more preferably n-butyl (meth)acrylate.

The monomer (c) represented by the formula (3) is now described.

R⁵ in the formula (3) is a hydrogen atom or a methyl group. Of these, a methyl group is preferred in terms of viscosity index improving effect.

—X³— in the formula (3) is a group represented by —O— or —NH—. Of these, a group represented by —O— is preferred in terms of viscosity index improving effect.

R⁶ in the formula (3) is a C2-C4 alkylene group.

Examples of the C2-C4 alkylene group include ethylene, 1,2- or 1,3-propylene, isobutylene, and 1,2-, 1,3- or 1,4-butylene groups.

R⁶O is a C2-C4 alkyleneoxy group. Examples include ethyleneoxy, 1,2- or 1,3-propyleneoxy, isobutyleneoxy, and 1,2-, 1,3- or 1,4-butyleneoxy groups.

r in the formula (3) is an integer of 1 to 20. In terms of viscosity index improving effect and low-temperature viscosity, r is preferably an integer of 1 to 5, more preferably 1 to 2.

Each R⁶O may be the same or different when r is 2 or more, and each R⁶O in the (R⁶O)ᵣ moiety may be bonded in a random form or a block form.

R⁷ in the formula (3) is a C1-C8 alkyl group. Examples include straight-chain or branched alkyl groups, such as methyl, ethyl, n-propyl, isopropyl, n-butyl, isobutyl, s-butyl, t-butyl, n-heptyl, isoheptyl, n-hexyl, 2-ethylhexyl, n-pentyl, and n-octyl groups.

In terms of viscosity index improving effect, the C1-C8 alkyl group is preferably a C1-C7 alkyl group, more preferably a C1-C6 alkyl group, particularly preferably a C1-C5 alkyl group, most preferably a C2 or C4 alkyl group.

Specific examples of the monomer (c) include methoxyethyl (meth)acrylate, ethoxyethyl (meth)acrylate, propoxyethyl (meth)acrylate, butoxyethyl (meth)acrylate, pentyloxyethyl (meth)acrylate, hexyloxyethyl (meth)acrylate, heptyloxyethyl (meth)acrylate, octyloxyethyl (meth)acrylate, methoxypropyl (meth)acrylate, ethoxypropyl (meth)acrylate, propoxypropyl (meth)acrylate, butoxypropyl (meth)acrylate, pentyloxypropyl (meth)acrylate, hexyloxypropyl (meth)acrylate, heptyloxypropyl (meth)acrylate, octyloxypropyl (meth)acrylate, methoxybutyl (meth)acrylate, ethoxybutyl (meth)acrylate, propoxybutyl (meth)acrylate, butoxybutyl (meth)acrylate, pentyloxybutyl (meth)acrylate, hexyloxybutyl (meth)acrylate, heptyloxybutyl (meth)acrylate, and octyloxybutyl (meth)acrylate, as well as esters of (meth)acrylic acid and an adduct of 2 to 20 moles of a C2-C4 alkylene oxide (at least one selected from the group consisting of ethylene oxide, propylene oxide, and butylene oxide) to C1-C8 alcohols.

In terms of viscosity index improving effect, the monomer (c) is preferably ethoxyethyl (meth)acrylate or butoxyethyl (meth)acrylate.

The monomer (d) represented by the formula (2) is now described.

In the monomer (d), R³ in the formula (2) is a hydrogen atom or a methyl group. Of these, a methyl group is preferred in terms of viscosity index improving effect.

The monomer (d) is a monomer represented by the formula (2) in which R⁴ is a C2-C3 alkyl group.

Examples of the C2-C3 alkyl group include ethyl, n-propyl, and isopropyl groups.

Specific examples of the monomer (d) include ethyl (meth)acrylate, n-propyl (meth)acrylate, isopropyl (meth)acrylate, N-ethyl (meth)acrylamide, and N-propyl (meth)acrylamide.

In terms of viscosity index improving effect, the monomer (d) is preferably ethyl (meth)acrylate.

In the copolymer (A), the weight percentage of the monomer (a) among the constituent monomers of the copolymer (A) is preferably 1 to 50 wt %, more preferably 2 to 30 wt % based on the total weight of the monomers constituting the copolymer (A), in terms of HTHS viscosity at 100° C., kinematic viscosity at 40° C., shear stability, and viscosity index improving effect.

In the copolymer (A), the weight percentage of the monomer (b) among the constituent monomers of the copolymer (A) is preferably 1 to 80 wt %, more preferably 3 to 70 wt % based on the total weight of the monomers constituting the copolymer (A), in terms of HTHS viscosity at 100° C., kinematic viscosity at 40° C., shear stability, and viscosity index improving effect.

In the copolymer (A), the weight percentage of the monomer (c) among the constituent monomers of the copolymer (A) is preferably 1 to 60 wt %, more preferably 2 to 40 wt % based on the total weight of the monomers constituting the copolymer (A), in terms of HTHS viscosity at 100° C., kinematic viscosity at 40° C., shear stability, and viscosity index improving effect.

In the copolymer (A), the total weight percentage of the monomer (c) and the monomer (d) among the constituent monomers of the copolymer (A) is preferably 1 to 60 wt %, more preferably 2 to 40 wt % based on the total weight of the monomers constituting the copolymer (A), in terms of shear stability and viscosity index improving effect.

In the copolymer (A), the weight percentage of the monomer (d) among the constituent monomers of the copolymer (A) is preferably 1 to 60 wt %, more preferably 2 to 40 wt % based on the total weight of the monomers constituting the copolymer (A), in terms of HTHS viscosity at 100° C., kinematic viscosity at 40° C., shear stability, and viscosity index improving effect.

In the copolymer (A), the weight ratio {(c+d)/b} of the total weight of the monomer (c) and the monomer (d) among the constituent monomers of the copolymer (A) to the weight of the monomer (b) is preferably 0.01 to 20, more preferably 0.03 to 5, still more preferably 0.05 to 2. When the weight ratio {(c+d)/b} is 0.01 or more, the gelation index and the viscosity index tend to be appropriate. When the weight ratio is 20 or less, the gelation index tends to be appropriate.

In the copolymer (A), the weight ratio (c/b) of the monomer (c) to the monomer (b) among the constituent monomers of the copolymer (A) is preferably 0.01 to 20, more preferably 0.03 to 5, still more preferably 0.05 to 2. When the weight ratio (c/b) is 0.01 or more, the gelation index and the viscosity index tend to be appropriate. When the weight ratio is 20 or less, the gelation index tends to be appropriate.

In the present invention, the copolymer (A) is preferably a copolymer containing, as a constituent monomer, a (meth)acryloyl monomer (e) having a C9-C36 straight-chain or branched alkyl group, in terms of solubility in the base oil.

Examples of the monomer (e) include a (meth)acryloyl monomer (e1) having a C9-C36 straight-chain alkyl group and a (meth)acryloyl monomer (e2) having a C9-C36 branched alkyl group represented by the following formula (4).

The monomer (e) may include one or more monomers (e).

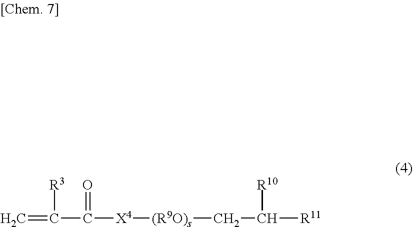

In the formula (4), R⁸ is a hydrogen atom or a methyl group; —X⁴— is a group represented by —O— or —NH—; R⁹O is a C2-C4 alkyleneoxy group; R¹⁰ and R¹¹ are each independently a C1-C24 straight-chain alkyl group, and the total carbon number of R¹⁰ and R¹¹ is 7 to 34; s is an integer of 0 to 20, and each R⁹O may be the same or different when s is 2 or more.

Examples of the (meth)acryloyl monomer (e1) (hereinafter sometimes abbreviated as the monomer (e1)) having a C9-C36 straight-chain alkyl group include (meth)acrylic acid alkyl esters {e.g., esters of C9-C36 straight-chain alkyl alcohols and (meth)acrylic acid, such as n-nonyl (meth)acrylate, n-decyl (meth)acrylate, n-undecyl (meth)acrylate, n-dodecyl (meth)acrylate, n-tridecyl (meth)acrylate, n-tetradecyl (meth)acrylate, n-pentadecyl (meth)acrylate, n-hexadecyl (meth)acrylate, n-octadecyl (meth)acrylate, n-icosyl (meth)acrylate, n-tetracosyl (meth)acrylate, n-triacontyl (meth)acrylate, and n-hexatriacontyl (meth)acrylate}; esters of (meth)acrylic acid and an adduct of 1 to 20 moles of an alkylene oxide (C2-C4) to a C9-C36 straight-chain alkyl alcohol; and methacrylic acid alkylamides {e.g., an amide of acrylic acid and a C9-C36 straight-chain alkylamine}.

In terms of viscosity index improving effect, the monomer (e1) is preferably an alkyl (meth)acrylate having a C12-C28 straight-chain alkyl group, more preferably an alkyl (meth)acrylate having a C12-C24 straight-chain alkyl group, particularly preferably an alkyl (meth)acrylate having a C12-C20 straight-chain alkyl group.

The monomer (e1) may include one or more monomers (e1).

In the monomer (e2), R⁸ in the formula (4) is a hydrogen atom or a methyl group. Of these, a methyl group is preferred in terms of viscosity index improving effect.

—X⁴ in the formula (4) is a group represented by —O— or —NH—. Of these, a group represented by —O— is preferred in terms of viscosity index improving effect.

R⁹ in the formula (4) is a C2-C4 alkylene group. Examples of the C2-C4 alkylene group include ethylene, 1,2-or 1,3-propylene, isobutylene, and 1,2-, 1,3-, or 1,4-butylene groups.

R⁹O is a C2-C4 alkyleneoxy group. Examples include ethyleneoxy, 1,2- or 1,3-propyleneoxy, isobutyleneoxy, and 1,2-, 1,3-, or 1,4-butyleneoxy groups.

s in the formula (4) is an integer of 0 to 20. In terms of viscosity index improving effect, s is preferably an integer of 0 to 5, more preferably 0 to 2.

Each R⁹O may be the same or different when s is 2 or more, and each R⁹O in the (R⁹O)ₛ moiety may be bonded in a random form or a block form.

R¹⁰ and R¹¹ in the formula (4) are each independently a C1-C24 straight-chain alkyl group. Specific examples include methyl, ethyl, n-propyl, n-butyl, n-heptyl, n-hexyl, n-pentyl, n-octyl, n-nonyl, n-decyl, n-undecyl, n-dodecyl, n-tetradecyl, n-hexadecyl, n-octadecyl, n-eicosyl, and n-tetracosyl groups. In terms of viscosity index improving effect, at least one of R¹⁰ and R¹ is preferably a C6-C24 straight-chain alkyl group, more preferably a C6-C20 straight-chain alkyl group, particularly preferably a C8-C16 straight-chain alkyl group among the C1-C24 straight-chain alkyl groups.

The total carbon number of R¹⁰ and R¹ is 7 to 34. In terms of viscosity index improving effect, the total carbon number is preferably 12 to 30, more preferably 14 to 26.

The carbon chain containing R¹⁰ and R¹¹ is a C9-C36 branched alkyl group in which one of R¹⁰ and R¹¹ is a branched chain. The carbon number of the branched alkyl group is 9 to 36. In terms of viscosity index improving effect, the carbon number is preferably 14 to 32, more preferably 16 to 28.

Specific examples of the monomer (e2) include 2-octyldecyl (meth)acrylate, esters of (meth)acrylic acid and ethylene glycol mono-2-octylpentadodecyl ether, 2-n-octyldodecyl (meth)acrylate, 2-n-decyltetradecyl (meth)acrylate, 2-n-dodecylhexadecyl (meth)acrylate, 2-n-tetradecyloctadecyl (meth)acrylate, 2-n-dodecylpentadecyl (meth)acrylate, 2-n-tetradecylheptadecyl (meth)acrylate, 2-n-hexadecylheptadecyl (meth)acrylate, 2-n-heptadecylicosyl (meth)acrylate, 2-n-hexadecyldocosyl (meth)acrylate, 2-n-eicosyldocosyl (meth)acrylate, 2-n-tetracosylhexacosyl (meth)acrylate, and N-2-octyldecyl (meth)acrylamide.

The monomer (e2) may include one or more monomers (e2).

In terms of solubility in the base oil and low-temperature viscosity, the monomer (e) is preferably the (meth)acryloyl monomer (e2) having a C9-C36 branched alkyl group represented by the formula (4), more preferably the monomer (e2) that is a (meth)acryloyl monomer having a C14-C32 branched alkyl group, particularly preferably the monomer (e2) that is a (meth)acryloyl monomer having a C16-C28 branched alkyl group.

In the copolymer (A), the weight percentage of the monomer (e) among the constituent monomers of the copolymer (A) is preferably 1 to 60 wt %, more preferably 5 to 35 wt % based on the total weight of the monomers constituting the copolymer (A), in terms of viscosity index improving effect and suitable SP of the copolymer (A).

The copolymer (A) in the present invention may further contain, as constituent monomers, a nitrogen atom-containing monomer (f), a hydroxy group-containing monomer (g), a phosphorus atom-containing monomer (h), an aromatic ring-containing vinyl monomer (i), and monomers (j) to (n), in addition to the monomers (a) to (e).

The monomers (f) to (n) may each include one or more monomers (f) to (n), respectively.

Examples of the nitrogen atom-containing monomer (f) include the following monomers (f1) to (f4), excluding the monomers (a) to (e).

### Amide Group-Containing Monomer (f1):

Examples include (meth)acrylamides, N-methyl (meth)acrylamides, N—(N′-monoalkylaminoalkyl) (meth)acrylamides (those having an aminoalkyl group (C2-C6) in which one C1-C4 alkyl group is bonded to a nitrogen atom, such as N—(N′-methylaminoethyl) (meth)acrylamide, N—(N′-ethylaminoethyl) (meth)acrylamide, N—(N′-isopropylamino-n-butyl) (meth)acrylamide, N—(N′-n-butylamino-n-butyl) (meth)acrylamide, and N—(N′-isobutylamino-n-butyl) (meth)acrylamide); dialkyl (meth)acrylamides (those in which two C1-C4 alkyl groups are bonded to a nitrogen atom, such as N,N-dimethyl (meth)acrylamide, N,N-diethyl (meth)acrylamide, N,N-diisopropyl (meth)acrylamide, and N,N-di-n-butyl (meth)acrylamide); N—(N′,N′-dialkylaminoalkyl) (meth)acrylamides (those having an aminoalkyl group (C2-C6) in which two C1-C4 alkyl groups are bonded to a nitrogen atom of an aminoalkyl group, such as N—(N′,N′-dimethylaminoethyl) (meth)acrylamide, N—(N′,N′-diethylaminoethyl) (meth)acrylamide, N—(N′,N′-dimethylaminopropyl) (meth)acrylamide, and N—(N′,N′-di-n-butylaminobutyl) (meth)acrylamide); and N-vinyl carboxylic acid amides, such as N-vinylformamide, N-vinylacetamide, N-vinyl-propionic acid amide, and N-vinylhydroxyacetamide.

### Nitro Group-Containing Monomer (f2):

Examples include 4-nitrostyrene.

### Primary to Tertiary Amino Group-Containing Monomer (f3):

Examples include primary amino group-containing monomers {C3-C6 alkenylamines (e.g., (meth)allylamine and crotylamine) and aminoalkyl (C2-C6) (meth)acrylates (e.g., aminoethyl (meth)acrylate)}; secondary amino group-containing monomers {monoalkylaminoalkyl (meth)acrylates (e.g., those having an aminoalkyl group (C2-C6) in which one C1-C6 alkyl group is bonded to a nitrogen atom, such as N-t-butylaminoethyl (meth)acrylate and N-methylaminoethyl (meth)acrylate), and C6-C12 dialkenylamines (e.g., di(meth)allylamine)}; tertiary amino group-containing monomers {dialkylaminoalkyl (meth)acrylates (e.g., those having an aminoalkyl group (C2-C6) in which two C1-C6 alkyl groups are bonded to a nitrogen atom, such as N,N-dimethylaminoethyl (meth)acrylate and N,N-diethylaminoethyl (meth)acrylate), alicyclic (meth)acrylates having a nitrogen atom such as morpholinoethyl (meth)acrylate, and aromatic monomers such as N—(N′,N′-diphenylaminoethyl) (meth)acrylamide, N,N-dimethylaminostyrene, 4-vinylpyridine, 2-vinylpyridine, N-vinylpyrrole, N-vinylpyrrolidone, and N-vinylthiopyrrolidone}; and hydrochlorides, sulfates, phosphates, and lower alkyl (C1-C8) monocarboxylic acid (e.g., acetic acid and propionic acid) salts of these monomers.

### Nitrile Group-Containing Monomer (f4):

Examples include (meth)acrylonitrile.

The monomer (f) is preferably the amide group-containing monomer (f1) or the primary to tertiary amino group-containing monomer (f3), more preferably N—(N′,N′-diphenylaminoethyl) (meth)acrylamide, N—(N′,N′-dimethylaminoethyl) (meth)acrylamide, N—(N′,N′-diethylaminoethyl) (meth)acrylamide, N—(N′,N′-dimethylaminopropyl) (meth)acrylamide, N,N-dimethylaminoethyl (meth)acrylate, or N,N-diethylaminoethyl (meth)acrylate.

### Hydroxy Group-Containing Monomer (g):

Examples include hydroxy group-containing aromatic monomers (e.g., p-hydroxystyrene), hydroxyalkyl (C2-C6) (meth)acrylates (e.g., 2-hydroxyethyl (meth)acrylate and 2-or 3-hydroxypropyl (meth)acrylate), mono- or bis-hydroxyalkyl (C1-C4) substituted (meth)acrylamides (e.g., N,N-bis(hydroxymethyl) (meth)acrylamide, N,N-bis(hydroxypropyl) (meth)acrylamide, and N,N-bis(2-hydroxybutyl) (meth)acrylamide), vinyl alcohol, C3-C12 alkenols (e.g., (meth)allyl alcohol, crotyl alcohol, isocrotyl alcohol, 1-octenol, and 1-undecenol), C4-C12 alkene monools or alkene diols (e.g., 1-buten-3-ol, 2-buten-1-ol, and 2-butene-1,4-diol), hydroxyalkyl (C1-C6) alkenyl (C3-C10) ethers (e.g., 2-hydroxyethylpropenyl ether), and alkenyl (C3-C10) ethers or (meth)acrylates of polyhydric (tri- to octahydric) alcohols (e.g., glycerol, pentaerythritol, sorbitol, sorbitan, diglycerol, sugars, and sucrose) (e.g., (meth)allylether of sucrose).

Examples also include mono(meth)acrylates of polyoxyalkylene glycols (carbon number of the alkylene group: C2-C4; polymerization degree: 2 to 50), polyoxyalkylene polyols (e.g., polyoxyalkylene ethers (carbon number of the alkylene group: C2-C4; polymerization degree: 2 to 100) of the tri- to octahydric alcohols), or alkyl (C1-C4) ethers of polyoxyalkylene glycols or polyoxyalkylene polyols (e.g., polyethylene glycol (Mn: 100 to 300) mono(meth)acrylate, polypropylene glycol (Mn: 130 to 500) mono(meth)acrylate, methoxy polyethylene glycol (Mn: 110 to 310) (meth)acrylate, lauryl alcohol ethylene oxide adduct (2 to 30 moles) (meth)acrylate, and polyoxyethylene (Mn: 150 to 230) sorbitan mono(meth)acrylate).

Examples of the phosphorus atom-containing monomer (h) include the following monomers (h1) and (h2).

Phosphate ester group-containing monomer (h1): Examples include (meth)acryloyloxyalkyl (C2-C4) phosphate esters ((meth)acryloyloxyethyl phosphate and (meth)acryloyloxy isopropyl phosphate) and alkenyl phosphate esters (e.g., vinyl phosphate, allyl phosphate, propenyl phosphate, isopropenyl phosphate, butenyl phosphate, pentenyl phosphate, octenyl phosphate, decenyl phosphate, and dodecenyl phosphate). The term “(meth)acryloyloxy” means acryloyloxy or methacryloyloxy.

### Phosphono Group-Containing Monomer (h2):

Examples include (meth)acryloyloxy alkyl (C2-C4) phosphonic acids (e.g., (meth)acryloyloxyethyl phosphonic acid) and alkenyl (C2-C12) phosphonic acids (e.g., vinylphosphonic acid, allylphosphonic acid, and octenylphosphonic acid).

The monomer (h) is preferably the phosphate ester group-containing monomer (h1), more preferably a (meth)acryloyloxyalkyl (C2-C4) phosphate ester, particularly preferably (meth)acryloyloxyethyl phosphate.

### Aromatic Ring-Containing Vinyl Monomer (i):

Examples include styrene, α-methylstyrene, vinyltoluene, 2,4-dimethylstyrene, 4-ethylstyrene, 4-isopropylstyrene, 4-butylstyrene, 4-phenylstyrene, 4-cyclohexylstyrene, 4-benzylstyrene, 4-crotylbenzene, indene, and 2-vinylnaphthalene.

The monomer (i) is preferably styrene or α-methylstyrene, more preferably styrene.

Examples of the monomer (j) having two or more unsaturated groups include divinylbenzene, C4-C12 alkadienes (e.g., butadiene, isoprene, 1,4-pentadiene, 1,6-heptadiene, and 1,7-octadiene), (di)cyclopentadiene, vinylcyclohexene, ethylidenebicycloheptene, limonene, ethylene di(meth)acrylate, polyalkylene oxide glycol di(meth)acrylate, pentaerythritol triallyl ether, pentaerythritol tri(meth)acrylate, pentaerythritol tetra(meth)acrylate, trimethylolpropane tri(meth)acrylate, and esters disclosed in WO 01/009242 such as an ester of an unsaturated carboxylic acid having a Mn of 500 or more and glycol and an ester of an unsaturated alcohol and a carboxylic acid.

Vinyl esters, vinyl ethers, vinyl ketones (k) (sometimes abbreviated as the monomer (k)): Examples include vinyl esters of C2-C12 saturated fatty acids (e.g., vinyl acetate, vinyl propionate, vinyl butyrate, and vinyl octanoate), C1-C12 alkyl, aryl, or alkoxyalkyl vinyl ethers (e.g., methyl vinyl ether, ethyl vinyl ether, propyl vinyl ether, butyl vinyl ether, 2-ethylhexyl vinyl ether, phenyl vinyl ether, vinyl-2-methoxyethyl ether, and vinyl-2-butoxyethyl ether), and C1-C8 alkyl or aryl vinyl ketones (e.g., methyl vinyl ketone, ethyl vinyl ketone, and phenyl vinyl ketone).

Epoxy group-containing monomer (1) (sometimes abbreviated as the monomer (1)):

Examples include glycidyl (meth)acrylate and glycidyl (meth)allyl ether.

Halogen-containing monomer (m) (sometimes abbreviated as the monomer (m)): Examples include vinyl chloride, vinyl bromide, vinylidene chloride, (meth)allyl chloride, and halogenated styrenes (e.g., dichlorostyrene).

Ester of unsaturated polycarboxylic acid (n) (sometimes abbreviated as the monomer (n)):

Examples include alkyl, cycloalkyl, or aralkyl esters of unsaturated polycarboxylic acids (C1-C8 alkyl diesters (dimethyl maleate, dimethyl fumarate, diethyl maleate, and dioctylmaleate) of unsaturated dicarboxylic acids (e.g., maleic acid, fumaric acid, and itaconic acid)).

In the copolymer (A), the weight percentage of the monomer (f) among the constituent monomers of the copolymer (A) is preferably 50 wt % or less, more preferably 1 to 40 wt % based on the total weight of the monomers constituting the copolymer (A), in terms of HTHS viscosity at an effective temperature and viscosity index improving effect.

In the copolymer (A), the weight percentage of the monomer (g) among the constituent monomers of the copolymer (A) is preferably 40 wt % or less, more preferably 1 to 30 wt % based on the total weight of the monomers constituting the copolymer (A), in terms of HTHS viscosity at an effective temperature and viscosity index improving effect.

In the copolymer (A), the weight percentage of the monomer (h) among the constituent monomers of the copolymer (A) is preferably 30 wt % or less, more preferably 1 to 20 wt % based on the total weight of the monomers constituting the copolymer (A), in terms of HTHS viscosity at an effective temperature and viscosity index improving effect.

In the copolymer (A), the weight percentage of the monomer (i) among the constituent monomers of the copolymer (A) is preferably 20 wt % or less, more preferably 1 to 15 wt % based on the total weight of the monomers constituting the copolymer (A), in terms of HTHS viscosity at an effective temperature and viscosity index improving effect.

In the copolymer (A), the weight percentage of the monomer (j) among the constituent monomers of the copolymer (A) is preferably 10 wt % or less, more preferably 1 to 5 wt % based on the total weight of the monomers constituting the copolymer (A), in terms of HTHS viscosity at an effective temperature.

In the copolymer (A), the weight percentage of the monomer (k) among the constituent monomers of the copolymer (A) is preferably 5 wt % or less, more preferably 0.5 to 2 wt % based on the total weight of the monomers constituting the copolymer (A), in terms of viscosity index improving effect.

In the copolymer (A), the weight percentage of the monomer (1) among the constituent monomers of the copolymer (A) is preferably 20 wt % or less, more preferably 1 to 10 wt % based on the total weight of the monomers constituting the copolymer (A), in terms of viscosity index improving effect.

In the copolymer (A), the weight percentage of the monomer (m) among the constituent monomers of the copolymer (A) is preferably 5 wt % or less, more preferably 0.1 to 2 wt % based on the total weight of the monomers constituting the copolymer (A), in terms of viscosity index improving effect.

In the copolymer (A), the weight percentage of the monomer (n) among the constituent monomers of the copolymer (A) is preferably 1 wt % or less, more preferably 0.01 to 0.5 wt % based on the total weight of the monomers constituting the copolymer (A), in terms of viscosity index improving effect.

The Mw of the copolymer (A) is preferably 5,000 to 2,000,000, more preferably 5,000 to 1,000,000, particularly preferably 10,000 to 800,000, most preferably 15,000 to 700,000, most preferably 30,000 to 600,000. When the copolymer (A) has a Mw of 5,000 or more, the viscosity temperature characteristic improving effect and the viscosity index improving effect tend to be good. It is also advantageous in terms of cost because the amount of the viscosity-index improving agent is not excessive. When the Mw is 2,000,000 or less, the shear stability tends to be good.

A preferred Mw range of the copolymer (A) is different depending on the application of the viscosity-index improving agent and the lubricating oil composition. Table 2 shows preferred ranges.

TABLE 2

| Application | More preferably | Still more preferably | Particularly preferably |
|---|---|---|---|
| Engine oil | 150,000 to 1,000,000 | 230,000 to 1,000,000 | 300,000 to 800,000 |
| ATF* | 5,000 to 150,000 | 10,000 to 80,000 | 12,000 to 55,000 |
| Belt-CVTF** | | | (most preferably 15,000 to |
| Gear oil, MFT*** | | | 50,000) |
| Traction fluids | 10,000 to 600,000 | 12,000 to 230,000 | 15,000 to 150,000 |

*Automatic transmission fluid
**Belt-continuously variable transmission fluid
***Manual transmission fluid

The Mn of the copolymer (A) is preferably 2,500 or more, more preferably 5,000 or more, particularly preferably 7,500 or more, most preferably 15,000 or more. The Mn is also preferably 300,000 or less, more preferably 150,000 or less, particularly preferably 100,000 or less.

When the Mn is 2,500 or more, the viscosity temperature characteristic improving effect and the viscosity index improving effect tend to be good. It is also advantageous in terms of cost because the amount of the viscosity-index improving agent is not excessive. When the Mn is 300,000 or less, the shear stability tends to be good.

The molecular weight distribution (Mw/Mn) of the copolymer (A) is preferably 1.0 to 4.0, more preferably 1.5 to 3.5 in terms of shear stability.

Conditions for measuring the Mw, Mn, and molecular weight distribution of copolymer (A) are the same as the conditions for measuring those of the monomer (a).

The copolymer (A) can be obtained by a known production method. Specific examples include a method in which one or more of the monomers are solution-polymerized in a solvent in the presence of a polymerization catalyst.

Examples of the solvent include toluene, xylene, C9-C10 alkylbenzenes, methyl ethyl ketone, mineral oils, synthetic oils, and mixtures of these.

Examples of the polymerization catalyst include azo catalysts (e.g., 2,2′-azobis(2-methylbutyronitrile) and 2,2′-azobis(2,4-dimethylvaleronitrile)), peroxide catalysts (e.g., benzoyl peroxide, cumyl peroxide, and lauryl peroxide), and redox catalysts (e.g., mixtures of benzoyl peroxide and tertiary amines).

A known chain transfer agent (e.g., C2-C20 alkylmercaptans) can also be used in order to further adjust the molecular weight, if necessary.

The polymerization temperature is preferably 25° C. to 140° C., more preferably 50° C. to 120° C. The copolymer (A) can also be obtained by bulk polymerization, emulsion polymerization, or suspension polymerization other than the solution polymerization.

The polymerization form of the copolymer (A) may be a random addition polymer, an alternating copolymer, a graft copolymer, or a block copolymer.

In terms of solubility in the base oil, the SP calculated based on weight fractions of the monomers constituting the copolymer (A) is preferably 8.0 to 10.0 (cal/cm³)^{1/2}, more preferably 8.5 to 9.5 (cal/cm³)^{1/2}.

The SP calculated based on weight fractions of the monomers constituting the copolymer (A) (sometimes abbreviated as the SP of the copolymer (A)) means a value obtained by calculating the SPs of the structural units (structures in which vinyl groups are polymerization reacted to form a single bond) derived from the monomers constituting the copolymer (A) using the SP calculation method described above, and calculating a weighted arithmetic mean based on weight fractions of the constituent monomers at the time of preparation. For example, when the monomer is methyl methacrylate, since a structural unit derived from methyl methacrylate contains two CH₃ atoms, one CH₂ atom, one C atom, and one CO₂ atom in the atomic group, the SP of the structural unit derived from methyl methacrylate is determined to be 9.933 (cal/cm³)^{1/2}. The SP of a structural unit derived from ethyl methacrylate is determined to be 9.721 (cal/cm³)^{1/2} by a similar calculation.

ΣΔeᵢ=1125×2+1180+350+4300=8080

ΣΔvᵢ=33.5×2+16.1−19.2+18.0=81.9

δ=(8080/81.9)^{1/2}=9.933 (cal/cm³)^{1/2}

When the copolymer is a polymer of 50 wt % methyl methacrylate and 50 wt % ethyl methacrylate, the SP of the copolymer is determined by calculating a weighted arithmetic mean of the SPs of the monomer-derived structural units based on weight fractions as described below.

SP of copolymer=(9.933×50+9.721×50)/100=9.827

The SP calculated based on weight fractions of the monomers constituting the copolymer (A) can be adjusted to a desired range by appropriately selecting the monomers to be used and adjusting the weight fractions of the monomers to be used. Specifically, use of many monomers having a high-carbon number alkyl group can result in a lower SP, and use of many monomers having a low-carbon number alkyl group can result in a higher SP.

In terms of useful life of the lubricating oil composition, the shear stability index (SSI) of the copolymer (A) is preferably 70 or less, more preferably 60 or less.

In the present invention, the SSI of the copolymer (A) indicates the percentage of reduction in viscosity by shearing of the copolymer (A). It is a value measured according to ASTM D6278. More specifically, it is a value calculated by the following formula (3).

SSI=(Kν₀−Kν₁)/(Kν₀−Kνₒᵢₗ) (3)

In the formula (3), Kν₀ indicates a value of kinematic viscosity at 100° C. of a sample oil obtained by diluting a viscosity-index improving agent containing the copolymer (A) in a mineral oil; and Kν₁ is a value of kinematic viscosity at 100° C. of the sample oil obtained by diluting the viscosity-index improving agent containing the copolymer (A) in a mineral oil after the sample oil has passed through a high-shear Bosch diesel injector for 30 cycles according to the procedures of ASTM D6278. Kνₒᵢₗ indicates a value of kinematic viscosity at 100° C. of the mineral oil used for dilution of the viscosity-index improving agent.

The viscosity-index improving agent of the present invention may further contain a (meth)acrylic acid alkyl ester (co)polymer (B) different from the copolymer (A), in addition to the copolymer (A). The presence of the (co)polymer (B) is preferred in terms of low-temperature viscosity.

The (co)polymer (B) may be a (co)polymer not containing the monomer (a). Examples include a (co)polymer containing, as a constituent monomer, the (meth)acryloyl monomer (e) having a C9-C36 straight-chain or branched alkyl group. Specific examples of include a n-dodecyl (meth)acrylate/n-tetradecyl (meth)acrylate/n-hexadecyl (meth)acrylate/n-octadecyl (meth)acrylate copolymer, a n-octadecyl (meth)acrylate/n-dodecyl (meth)acrylate (molar ratio of 10-30/90-70) copolymer, a n-tetradecyl (meth)acrylate/n-dodecyl (meth)acrylate (molar ratio: 10-30/90-70) copolymer, a n-hexadecyl (meth)acrylate/n-dodecyl (meth)acrylate/methyl (meth)acrylate (molar ratio: 20-40/55-75/0-10)copolymer, and a n-dodecyl acrylate/n-dodecyl methacrylate (molar ratio: 10-40/90-60) copolymer. These may be used alone or in combination of two or more.

In terms of low-temperature viscosity, the amount of the (co)polymer (B) in the viscosity-index improving agent of the present invention is preferably 0.01 to 30 wt %, more preferably 0.01 to 10 wt % based on the weight of the copolymer (A).

In terms of lower pour point temperature, the Mw of the (co)polymer (B) is preferably 5,000 to 100,000, more preferably 10,000 to 80,000.

In terms of solubility in the base oil, the SP calculated based on weight fractions of the monomers constituting the (co)polymer (B) is preferably 7.0 to 10, more preferably 8.0 to 9.5.

Conditions for measuring the Mw of the (co)polymer (B) are the same as the conditions for measuring the Mw of the monomer (a), and the method of calculating the SP of the (co)polymer (B) is the same as the method of calculating the SP of the copolymer (A).

In terms of viscosity index improving effect and low-temperature viscosity, preferably, the viscosity-index improving agent of the present invention contains the copolymer (A) in an amount of 10 wt % or more and 40 wt % or less based on the weight of the viscosity-index improving agent.

In terms of low-temperature viscosity, preferably, the viscosity-index improving agent of the present invention contains the (co)polymer (B) in an amount of 0.01 to 5 wt % based on the weight of the viscosity-index improving agent.

### <Ester Oil (Z)>

The viscosity-index improving agent of the present invention contains the copolymer (A) and an ester oil (Z). The ester oil may include one or more ester oils. The viscosity-index improving agent of the present invention contains the ester oil (Z) and the copolymer (A) containing, as constituent monomers, the monomer (a), the monomer (b), and at least one of the monomer (c) and the monomer (d). Thus, the viscosity-index improving agent tends to have a low viscosity and a good handleability even when the copolymer (A) having a high molecular weight is present at a high concentration, and such a viscosity-index improving agent can be easily taken out from a reactor after production. Further, when the viscosity-index improving agent of the present invention is diluted to provide a lubricating oil composition, since the viscosity-index improving agent contains the ester oil (Z), presumably, the molecules easily spread at high temperatures and easily aggregate at low temperatures so that the copolymer (A) has a good molecular behavior, as compared to when the lubricating oil composition contains only a hydrocarbon oil as an oil component. Thus, the lubricating oil composition has an excellent HTHS viscosity at 100° C., an excellent kinematic viscosity at 40° C., and an appropriate gelation index.

The ester oil (Z) is not limited as long as it is a lubricating ester that has been conventionally used as a lubricating oil. Examples include an ester of a dicarboxylic acid and an alcohol which is described in JP H11-172267 A, an ester of a monocarboxylic acid and a diol which is described in JP 2003-321691 A, and a phosphate ester which is described in JP H10-77494 A.

In terms of low-temperature viscosity, preferred of these are an ester oil (z1) that is an ester of a C4-C16 aliphatic saturated dicarboxylic acid and a C6-C24 aliphatic saturated monohydric alcohol, and an ester oil (z2) that is an ester of a C6-C24 aliphatic saturated monovalent carboxylic acid and a C4-C16 aliphatic saturated dihydric alcohol.

In terms of kinematic viscosity at 40° C., the ester oil (Z) is preferably an ester having a total carbon number of 10 to 40, more preferably an ester having a total carbon number of 15 to 35.

Regarding the ester oil (z1) that is an ester of a C4-C16 aliphatic saturated dicarboxylic acid and a C6-C24 aliphatic saturated monohydric alcohol, examples of the C4-C16 aliphatic saturated dicarboxylic acid include straight-chain saturated alkyl dicarboxylic acids {e.g., n-butanedioic acid (succinic acid), n-heptanedioic acid (glutaric acid), n-hexanedioic acid (adipic acid), n-heptanedioic acid, n-octanedioic acid, n-nonanedioic acid, n-decanedioic acid (sebacic acid), n-undecanedioic acid, n-dodecanedioic acid, n-tridecanedioic acid, n-tetradecanedioic acid, n-pentadecanedioic acid, and n-hexadecanedioic acid}, branched saturated alkyl dicarboxylic acids {e.g., 3-methyladipic acid}, and alicyclic saturated dicarboxylic acids {e.g., 1,2- or 1,3-cyclopentane dicarboxylic acid, and 1,2-, 1,3-, or 1,4-cyclohexane dicarboxylic acid}.

Regarding the ester oil (z1), examples of the C6-C24 aliphatic saturated monohydric alcohol include straight-chain saturated alkyl monoalcohols {e.g., n-hexanol, n-heptanol, n-octanol, n-nonanol, n-decanol, n-undecyl alcohol, n-dodecyl alcohol, n-tridecyl alcohol, n-tetradecyl alcohol, n-pentadecyl alcohol, n-hexadecyl alcohol, n-heptadecyl alcohol, n-octadecyl alcohol, n-nonadecyl alcohol, n-eicosanol, n-heneicosanol, n-docosanol, and n-tetracosanol}, branched saturated alkyl monoalcohols {e.g., 2-ethylhexanol, isononyl alcohol, isodecyl alcohol, isoundecyl alcohol, isododecyl alcohol, isotridecyl alcohol, isotetradecyl alcohol, isopentadecyl alcohol, isohexadecyl alcohol, isoheptadecyl alcohol, isooctadecyl alcohol, and isononadecyl alcohol}, alicyclic monoalcols {e.g., cyclohexanol, 2-, 3-, or 4-t-butyl cyclohexanol, menthol, cyclohexane ethanol, and 2-, 3-, or 4-isopropyl cyclohexanol}.

Specific examples of the ester oil (z1) include di(2-ethylhexyl) hexanedioate {sometimes described as bis(2-ethylhexyl) adipate)}, diisodecyl hexanedioate {sometimes described as diisodecyl adipate}, didecyl heptanedioate, diundecyl heptanedioate, didodecyl heptanedioate, diisodecyl heptanedioate, diisoundecyl heptanedioate, diisododecyl heptanedioate, di(2-ethylhexyl) heptanedioate, dinonyl octanedioate, didecyl octanedioate, diundecyl octanedioate, diisononyl octanedioate, diisodecyl octanedioate, di(2-ethylhexyl) octanedioate, diisoundecyl decanedioate, dioctyl nonanedioate, dinonyl nonanedioate, didecyl nonanedioate, diisooctyl nonanedioate, diisononyl nonanedioate, diisodecyl nonanedioate, di(2-ethylhexyl) nonanedioate, dioctyl decanedioate, di(2-ethylhexyl)decanedioate {sometimes described as bis(2-ethylhexyl) sebacate}, dinonyl decanedioate, and didecyl decanedioate.

In terms of low-temperature viscosity, the ester oil (z1) is preferably an ester of a C4-C16 straight-chain saturated alkyl dicarboxylic acid and a C6-C24 aliphatic saturated monohydric alcohol, more preferably an ester of a C4-C16 straight-chain saturated alkyl dicarboxylic acid and a C6-C24 branched saturated alkyl monoalcohol, particularly preferably an ester of a C4-C10 straight-chain saturated alkyl dicarboxylic acid and a C6-C20 branched saturated alkyl monoalcohol.

Regarding the ester oil (z2), examples of the C6-C24 aliphatic saturated monovalent carboxylic acid include straight-chain saturated alkyl monocarboxylic acids {e.g., n-hexanoic acid, n-heptanoic acid, n-octanoic acid, n-nonanoic acid, n-decanoic acid, n-undecanoic acid, n-dodecanoic acid, n-tridecanoic acid, n-tetradecanoic acid, n-pentadecanoic acid, n-hexadecanoic acid, n-heptadecanoic acid, n-octadecanoic acid, n-nonadecanoic acid, n-eicosanoic acid, n-docosanoic acid and n-tetracosanoic acid}, branched saturated alkyl monocarboxylic acids {e.g., 2-ethylhexanoic acid, isononanoic acid, isodecanoic acid, isoundecanoic acid, isododecanoic acid, isotridecanoic acid, isotetradecanoic acid, isopentadecanoic acid, isohexadecanoic acid, isoheptadecanoic acid, isooctadecanoic acid, and isononadecanoic acid}, and alicyclic monocarboxylic acids {e.g., cyclohexane carboxylic acid}.

Regarding the ester oil (z2), examples of the C4-C16 aliphatic saturated dihydric alcohol include straight-chain saturated alkyl diols {e.g., 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, and 1,16-hexadecanediol}, branched saturated alkyl diols {e.g., 2-methyl-1,3-propanediol, 2-methyl-1,4-butanediol, 1,2-butanediol, 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, 1,2-pentadecanediol, and 1,2-hexadecanediol}, and alicyclic diols {e.g., 1,2-, 1,3-, or 1,4-cyclohexanediol}.

In terms of low-temperature viscosity, the ester oil (z2) is preferably an ester of a C6-C24 aliphatic saturated monovalent carboxylic acid and a C4-C16 straight-chain saturated alkyl diol, more preferably an ester of a C6-C24 branched saturated alkyl monocarboxylic acid and a C4-C16 straight-chain saturated alkyl diol, particularly preferably an ester of a C6-C20 branched saturated alkyl monocarboxylic acid and a C4-C12 straight-chain saturated alkyl diol.

In terms of low-temperature kinematic viscosity, the kinematic viscosity at 100° C. of the ester oil (Z) (as measured according to JIS-K2283) is preferably 1 to 4 mm²/s, more preferably 1.5 to 3.6 mm²/s.

The kinematic viscosity at 100° C. of the ester oil (Z) can be adjusted by changing the carbon number of a carboxylic acid and an alkyl alcohol during synthesis of the ester oil (Z). Specifically, use of one having a higher carbon number increases the kinematic viscosity at 100° C.

In terms of viscosity index of the lubricating oil composition, the viscosity index of the ester oil (Z) (as measured according to JIS-K2283) is preferably 100 or more, more preferably 105 to 180.

The viscosity index of the ester oil (Z) can be adjusted by changing the carbon number of a carboxylic acid and an alkyl alcohol during synthesis of the ester oil (Z). Specifically, use of one having a higher carbon number increases the viscosity index.

In terms of solubility of various additives, the SP of the ester oil (Z) is preferably 8.0 to 10.0 (cal/cm³)^{1/2}, more preferably 8.5 to 9.5 (cal/cm³)^{1/2}.

In terms of compatibility, the absolute difference between the SP as calculated based on weight fractions of the monomers constituting the copolymer (A) and the SP of the ester oil (Z) is preferably 0.1 to 2.0 (cal/cm³)^{1/2}, more preferably 0.1 to 1.5 (cal/cm³)^{1/2}, particularly preferably 0.1 to 1.0 (cal/cm³)^{1/2}.

In terms of handleability of the viscosity-index improving agent as well as gelation index and evaporability at 250° C. of the lubricating oil composition, the weight ratio ((A)/(Z)) of the copolymer (A) to the ester oil (Z) in the viscosity-index improving agent of the present invention is preferably 10/90 to 70/30, more preferably 10/90 to 60/40, particularly preferably 25/75 to 45/55. With this range, the resulting viscosity-index improving agent tends to have a low viscosity (e.g., low viscosity at 90° C.) and a good handleability. When the lubricating oil composition is produced using a hydrocarbon oil as a base oil, the weight ratio ((A)/(Z)) in the lubricating oil composition is the above rate. Thus, the lubricating oil composition tends to have an appropriate gelation index and a good evaporability at 250° C.

In terms of handleability of the viscosity-index improving agent as well as HTHS viscosity reduction and low-temperature viscosity of the resulting lubricating oil composition, preferably, the viscosity-index improving agent of the present invention contains the ester oil (Z) in an amount of 30 to 90 wt %, more preferably 40 to 89 wt %, particularly preferably 50 to 87 wt % based on the weight of the viscosity-index improving agent. With this range, the lubricating oil composition produced using a hydrocarbon oil as a base oil contains an appropriate amount of ester oil and tends to have a low HTHS viscosity and an excellent low-temperature viscosity.

In terms of handleability of the viscosity-index improving agent as well as gelation index and evaporability at 250° C. of the lubricating oil composition, preferably, the viscosity-index improving agent of the present invention contains the copolymer (A) in an amount of 10 to 70 wt %, more preferably 10 to 40 wt %, particularly preferably 12 to 40 wt % based on the weight of the viscosity-index improving agent.

In terms of handleability of the viscosity-index improving agent, the kinematic viscosity at 90° C. of the viscosity-index improving agent (as measured according to JIS-K2283) is preferably 100 to 20000 mm²/s, more preferably 300 to 12000 mm²/s.

The viscosity-index improving agent of the present invention may further contain a base oil different from the ester oil (Z). In terms of oxidative stability of the viscosity-index improving agent as well as oxidative stability and evaporability at 250° C. of the lubricating oil composition, preferably, the viscosity-index improving agent contains a base oil different from the ester oil (Z).

The base oil different from the ester oil (Z) may be a hydrocarbon oil. Specific examples include hydrocarbon oils of API Groups I to IV.

In terms of solubility of various additives, the SP of the hydrocarbon oil is preferably 7.8 to 9.5 (cal/cm³)^{1/2}, more preferably 8.0 to 9.0 (cal/cm³)^{1/2}.

In the case of using a mixture of multiple hydrocarbon compounds as a hydrocarbon oil (e.g., a mineral oil), approximate constituent components and molecular structure thereof can be determined by molecular weight measurement by GPC and molecular structure analysis by ¹H-NMR, ¹³C-NMR, and the like. The SP of the hydrocarbon oil can be determined by calculating a weighted arithmetic mean based on molar fractions.

In the viscosity-index improving agent of the present invention, the absolute difference between the SP of the ester oil (Z) and the SP of the hydrocarbon oil is preferably 0.1 to 2.0 (cal/cm³)^{1/2}, more preferably 0.2 to 1.5 (cal/cm³)^{1/2}, particularly preferably 0.3 to 1.0 (cal/cm³)^{1/2}, in terms of compatibility.

In the viscosity-index improving agent of the present invention, the absolute difference between the SP as calculated based on weight fractions of the monomers constituting the copolymer (A) and the SP of the hydrocarbon oil is preferably 0.8 to 2.0 (cal/cm³)^{1/2}, more preferably 0.8 to 1.3 (cal/cm³)^{1/2}, particularly preferably 0.9 to 1.2 (cal/cm³)^{1/2}, in terms of compatibility. The absolute difference between the SP as calculated based on weight fractions of the monomers constituting the copolymer (A) and the SP of the hydrocarbon oil can be adjusted to a desired range by appropriately adjusting the types of monomers for use in production of the copolymer (A) and weight fractions of these monomers relative to the base oil.

In terms of viscosity index and low-temperature fluidity, the kinematic viscosity at 100° C. of the hydrocarbon oil (as measured according to JIS-K2283) is preferably 1 to 15 mm²/s, more preferably 2 to 5 mm²/s.

In terms of viscosity index and low-temperature fluidity of the lubricating oil composition, the viscosity index of the hydrocarbon oil (as measured according to JIS-K2283) is preferably 100 or more.

In terms of oxidative stability of the viscosity-index improving agent as well as oxidative stability, evaporability at 250° C., and low-temperature viscosity of the lubricating oil composition produced using a hydrocarbon oil as a base oil, the weight ratio ((Z)/hydrocarbon oil) of the ester oil (Z) to the hydrocarbon oil in the viscosity-index improving agent is preferably 40/60 to 100/0, more preferably 50/50 to 95/5.

In terms of HTHS viscosity, the weight ratio ((A)/hydrocarbon oil) of the copolymer (A) to the hydrocarbon oil in the viscosity-index improving agent is preferably 10/90 to 100/0, more preferably 20/80 to 90/10.

In terms of oxidative stability of the viscosity-index improving agent as well as oxidative stability and evaporability at 250° C. of the lubricating oil composition, preferably, the viscosity-index improving agent of the present invention contains a hydrocarbon oil in an amount of 1 to 35 wt % based on the weight of the viscosity-index improving agent.

The cloud point of the hydrocarbon oil (as measured according to JIS K 2269) is preferably −5° C. or lower, more preferably −15° C. or lower. When the cloud point of the hydrocarbon oil is in this range, the lubricating oil composition tends to have a good low-temperature viscosity.

### <Lubricating Oil Composition>

The lubricating oil composition of the present invention contains the viscosity-index improving agent of the present invention and at least one additive selected from the group consisting of a detergent, a dispersant, an antioxidant, an oiliness improver, a pour point depressant, a friction and wear modifier, an extreme pressure agent, a defoamer, a demulsifier, a metal deactivator, and a corrosion inhibitor.

In terms of low fuel consumption, preferably, the lubricating oil composition of the present invention contains the copolymer (A) in an amount of 0.1 wt % or more and less than 10 wt %, more preferably 0.5 wt % or more and less than 10 wt % based on the weight of the lubricating oil composition.

In terms of low-temperature viscosity, preferably, the lubricating oil composition of the present invention contains the (co)polymer (B) in an amount of 0.01 to 2 wt % based on the weight of the lubricating oil composition.

In terms of gelation index, low-temperature viscosity, HTHS viscosity at 100° C., and kinematic viscosity at 40° C., preferably, the lubricating oil composition of the present invention contains the ester oil (Z) in an amount of 1 to 99.9 wt %, more preferably 1 to 30 wt % based on the weight of the lubricating oil composition.

In terms of oxidative stability, preferably, the lubricating oil composition of the present invention contains a hydrocarbon oil in an amount of 98.89 wt % or less, more preferably 50 to 90 wt % based on the weight of the lubricating oil composition.

The lubricating oil composition used as an engine oil is preferably a base oil having a kinematic viscosity at 100° C. of 2 to 10 mm²/s (the ester oil (Z) or a mixture of the ester oil (Z) and a hydrocarbon oil) containing the copolymer (A) in an amount of 1 wt % or more and less than 10 wt %.

The lubricating oil composition used as a gear oil is preferably a base oil having a kinematic viscosity at 100° C. of 2 to 10 mm²/s (the ester oil (Z) or a mixture of the ester oil (Z) and a hydrocarbon oil) containing the copolymer (A) in an amount of 3 to 20 wt %.

The lubricating oil composition used as an automatic transmission oil (e.g., ATF or belt-CVTF) is preferably a base oil having a kinematic viscosity at 100° C. of 2 to 6 mm²/s (the ester oil (Z) or a mixture of the ester oil (Z) and a hydrocarbon oil) containing the copolymer (A) in an amount of 3 to 20 wt %.

The lubricating oil composition used as a traction oil is preferably a base oil having a kinematic viscosity at 100° C. of 1 to 5 mm²/s (the ester oil (Z) or a mixture of the ester oil (Z) and a hydrocarbon oil) containing the copolymer (A) in an amount of 0.5 to 10 wt %.

In terms of gelation index, low-temperature viscosity, HTHS viscosity at 100° C. and kinematic viscosity at 40° C., the weight ratio ((A)/(Z)) of the copolymer (A) to the ester oil (Z) in the lubricating oil composition of the present invention is preferably 10/90 to 70/30, more preferably 10/90 to 60/40, particularly preferably 25/75 to 45/55.

In terms of gelation index, low-temperature viscosity, HTHS viscosity at 100° C., kinematic viscosity at 40° C., oxidative stability, and evaporability at 250° C., the weight ratio ((Z)/hydrocarbon oil) of the ester oil (Z) to the hydrocarbon oil in the lubricating oil composition is preferably 1/99 to 20/80, more preferably 2/98 to 9/91. The weight ratio ((Z)/hydrocarbon oil) in the above range tends to be able to improve the gelation index, low-temperature viscosity, HTHS viscosity at 100° C., and kinematic viscosity at 40° C. of the resulting lubricating oil composition without reducing the oxidative stability and evaporability at 250° C.

In terms of HTHS viscosity, the weight ratio ((A)/hydrocarbon oil) of the copolymer (A) to the hydrocarbon oil in the lubricating oil composition is preferably 99.9/0.1 to 1/99, more preferably 99/1 to 10/90.

The lubricating oil composition of the present invention contains various additives. Examples of the additives include the followings.

### (1) Detergent:

Examples include basic, overbased, or neutral metal salts (e.g., overbased metal salts or alkaline earth metal salts of sulfonates such as petroleum sulfonate, alkylbenzene sulfonate, and alkylnaphthalene sulfonate), salicylates, phenates, naphthenates, carbonates, phosphonates, and mixtures of detergents.

### (2) Dispersant:

Examples include succinimides (bis- or mono-polybutenyl succinimides), Mannich condensates, and borates.

### (3) Antioxidant:

Examples include hindered phenols and aromatic secondary amines.

### (4) Oiliness Improver:

Examples include long-chain fatty acids and their esters (e.g., oleic acid and its ester), long-chain amines and their amides (e.g., oleylamine and oleylamide).

### (5) Pour Point Depressant:

Examples include polyalkylmethacrylates and ethylene-vinyl acetate copolymers.

### (6) Friction and Wear Modifier:

Examples include molybdenum-based compounds and zinc-based compounds (e.g., molybdenum dithiophosphate, molybdenum dithiocarbamate, and zinc dialkyldithiophosphate).

### (7) Extreme Pressure Agent:

Examples include sulfur-based compounds (mono- or disulfide, sulfoxide, and sulfur phosphide compounds), phosphide compounds, and chlorinated compounds (e.g., chlorinated paraffin).

### (8) Defoamer:

Examples include silicone oils, metallic soap, fatty acid esters, and phosphate compounds.

### (9) Demulsifier:

Examples include quaternary ammonium salts (e.g., tetraalkyl ammonium salt), sulfonated oil and phosphates (e.g., phosphates of polyoxyethylene-containing nonionic surfactant), and hydrocarbon-based solvents (toluene, xylene, and ethyl benzene).

### (10) Metal Deactivator

Examples include nitrogen atom-containing compounds (e.g., benzotriazole), nitrogen atom-containing chelate compounds (e.g., N,N′-disalicylidene-1,2-diaminopropane), and nitrogen/sulfur atom-containing compounds (e.g., 2-(n-dodecylthio)benzimidazole).

### (11) Corrosion Inhibitor:

Examples include nitrogen-containing compounds (e.g., benzotriazole and 1,3,4-thiadiazolyl-2,5-bisdialkyldithiocarbamate).

Only one of these additives may be added, or two or more additives may be added if necessary. A mixture of these additives may be referred to as a performance additive or a package additive, and such a mixture may be added.

The amount of each of these additives is preferably 0.1 to 15% by weight based on the total amount of the lubricating oil composition. The total amount of these additives is preferably 0.1 to 30% by weight, more preferably 0.3 to 20% by weight based on the total amount of the lubricating oil composition.

The lubricating oil composition of the present invention is suitably used for gear oils (e.g., differential oil and industrial gear oil), MTF, transmission fluids (e.g., ATF, DCTF, and belt-CVTF), traction fluids (e.g., toroidal-CVTF), shock absorber fluids, power steering fluids, hydraulic oils (e.g., construction machinery hydraulic oil and industrial hydraulic oil), and engine oils (e.g., gasoline engine and diesel engine).

### EXAMPLES

The present invention is described in further detail below with reference to examples and comparative examples, but the present invention is not limited to these examples.

The proportion of the 1,2-butylene in the structural units of the hydrocarbon polymer was determined by analyzing the polymer by ¹³C-NMR and calculating using the formula (1) according to the above method.

The molar ratio of a 1,2-adduct to a 1,4-adduct (molar ratio in a structure derived from butadiene) in the hydrocarbon polymer was determined by analyzing the polymer by ¹³C-NMR and substituting the integral value B and the integral value C used in the formula (1) into the following formula (3).

Molar ratio of 1,2-adduct/1,4-adduct={100×integral value B×4/integral value C}/{100−(100×integral value B×4/integral value C)} (3)

### Production Example 1

A 1-L SUS pressure-resistant reaction vessel equipped with a temperature adjuster and a stirrer was charged with degassed and dehydrated hexane (400 parts by weight), tetrahydrofuran (0.5 part by weight), 1,3-butadiene (90 parts by weight), and n-butyllithium (0.9 parts by weight), followed by polymerization at a polymerization temperature of 50° C.

After the polymerization proceeded to almost 100%, ethylene oxide (2 parts by weight) was added. The mixture was reacted at 50° C. for additional three hours. To terminate the reaction, water (50 parts by weight) and a 1 N aqueous hydrochloric acid solution (25 parts by weight) were added to the mixture, followed by stirring at 80° C. for one hour. The organic phase of the reaction solution was collected in a separating funnel, and heated to 70° C. Then, the solvent was removed under reduced pressure of 0.027 to 0.040 MPa over two hours.

The resulting polybutadiene having a hydroxy group at one end was transferred to a reaction vessel equipped with a temperature adjuster, a stirrer, and a hydrogen inlet tube, and tetrahydrofuran (150 parts by weight) was added and uniformly dissolved therein. To the resulting solution was added a suspension obtained in advance by mixing palladium on carbon (10 parts by weight) and tetrahydrofuran (50 parts by weight). Then, the mixture was reacted at room temperature for eight hours while hydrogen was supplied at a flow rate of 30 mL/min through the hydrogen inlet tube into the solution. Subsequently, the palladium on carbon was filtered out. The resulting filtrate was heated to 70° C., and tetrahydrofuran was removed under reduced pressure of 0.027 to 0.040 MPa. Thus, a hydrogenated polybutadiene polymer having a hydroxy group at one end (Y-1) was obtained.

The molecular weight of the resulting (Y-1) was measured by GPC, and the proportion of the 1,2-butylene group was measured by ¹³C-NMR. The results were as follows: Mw=7,000, Mn=6,500, proportion of the 1,2-butylene group=45 mol %, and molar ratio (1,2-adduct/1,4-adduct)=45/55.

### Production Example 2

A 1-L SUS pressure-resistant reaction vessel equipped with a temperature adjuster and a stirrer was charged with degassed and dehydrated hexane (400 parts by weight), tetrahydrofuran (2 parts by weight), 1,3-butadiene (90 parts by weight), and n-butyllithium (0.9 parts by weight), followed by polymerization at a polymerization temperature of minus 0° C.

After the polymerization proceeded to almost 100%, ethylene oxide (2 parts by weight) was added, and the mixture was reacted at 50° C. for three hours. To terminate the reaction, water (50 parts by weight) and a 1 N aqueous hydrochloric acid solution (25 parts by weight) were added to the mixture, followed by stirring at 80° C. for one hour. The organic phase of the reaction solution was collected in a separating funnel, and heated to 70° C. Then, the solvent was removed under reduced pressure of 0.027 to 0.040 MPa over two hours.

The resulting polybutadiene having a hydroxy group at one end was transferred to a reaction vessel equipped with a temperature adjuster, a stirrer, and a hydrogen inlet tube, and tetrahydrofuran (150 parts by weight) was added and uniformly dissolved therein. To the resulting solution was added a suspension obtained in advance by mixing palladium on carbon (10 parts by weight) and tetrahydrofuran (50 parts by weight). Then, the mixture was reacted at room temperature for eight hours while hydrogen was supplied at a flow rate of 30 mL/min through the hydrogen inlet tube into the solution. Subsequently, the palladium on carbon was filtered out. The resulting filtrate was heated to 70° C., and tetrahydrofuran was removed under reduced pressure of 0.027 to 0.040 MPa. Thus, a hydrogenated polybutadiene polymer having a hydroxy group at one end (Y-2) was obtained.

The molecular weight of the resulting (Y-2) was measured by GPC, and the proportion of the 1,2-butylene group was measured by ¹³C-NMR. The results were as follows: Mw=7,000, Mn=6,500, proportion of the 1,2-butylene group=65 mol %, and molar ratio (1,2-adduct/1,4-adduct)=65/35.

### Production Example 3: Production of Copolymer Composition (B-1)

A reaction vessel equipped with a stirrer, a heating and cooling device, a thermometer, a dropping funnel, a nitrogen inlet tube, and a decompressor was charged with a hydrocarbon oil 1 (kinematic viscosity at 100° C.: 4.2 mm²/s; viscosity index: 122) (75 parts by weight). Separately, a glass beaker was charged with n-dodecyl methacrylate (244 parts by weight), n-tetradecyl methacrylate (24 parts by weight), n-hexadecyl methacrylate (41 parts by weight), n-octadecyl methacrylate (16 parts by weight), dodecylmercaptan as a chain transfer agent (0.6 parts by weight), 2,2-azobis(2,4-dimethylvaleronitrile) (0.5 parts by weight), and 2,2-azobis(2-methylbutyronitrile) (0.2 parts by weight), followed by stirring at 20° C. and mixing to prepare a monomer solution, which was then introduced into the dropping funnel.

After purging the gas phase in the reaction vessel with nitrogen (gas phase oxygen concentration: 100 ppm or less), the monomer solution was added dropwise over two hours with the temperature in the system maintained at 70° C. to 85° C. under hermetically sealed conditions. The mixture was aged at 85° C. for two hours after completion of the dropwise addition. Subsequently, after heating to 120° C. to 130° C., unreacted monomers were removed at the same temperature under reduced pressure (0.027 to 0.040 MPa) over two hours. Thus, a copolymer composition (B-1) containing a copolymer (B) in an amount of 65 wt % in the hydrocarbon oil was separately obtained. The resulting copolymer (B) had a Mw of 53,000 and a SP of 9.0.

### Production Example 4: Production of Copolymer Composition (B-2)

A reaction vessel equipped with a stirrer, a heating and cooling device, a thermometer, a dropping funnel, a nitrogen inlet tube, and a decompressor was charged with an ester oil (Z-1) (bis(2-ethylhexyl) adipate; kinematic viscosity at 100° C.: 2.3 mm²/s; viscosity index: 118) (75 parts by weight). Separately, a glass beaker was charged with n-dodecyl methacrylate (244 parts by weight), n-tetradecyl methacrylate (24 parts by weight), n-hexadecyl methacrylate (41 parts by weight), n-octadecyl methacrylate (16 parts by weight), dodecylmercaptan as a chain transfer agent (0.6 parts by weight), 2,2-azobis(2,4-dimethylvaleronitrile) (0.5 parts by weight), and 2,2-azobis(2-methylbutyronitrile) (0.2 parts by weight), followed by stirring at 20° C. and mixing to prepare a monomer solution, which was then introduced into the dropping funnel.

After purging the gas phase in the reaction vessel with nitrogen (gas phase oxygen concentration: 100 ppm or less), the monomer solution was added dropwise over two hours with the temperature in the system maintained at 70° C. to 85° C. under hermetically sealed conditions. The mixture was aged at 85° C. for two hours after completion of the dropwise addition. Subsequently, after heating to 120° C. to 130° C., unreacted monomers were removed at the same temperature under reduced pressure (0.027 to 0.040 MPa) over two hours. Thus, a copolymer composition (B-2) containing a copolymer (B) in an amount of 65 wt % in the ester oil was separately obtained. The resulting copolymer (B) had a Mw of 53,000 and a SP of 9.0.

### Examples 1 to 28, Comparative Examples 1 to 4

A reaction vessel equipped with a stirrer, a heating and cooling device, a thermometer, and a nitrogen inlet tube was charged with a base oil, a monomer formulation, and a catalyst described in Table 3-1, Table 3-2, or Table 4 in amounts described in Table 3-1, Table 3-2, or Table 4. After purging with nitrogen (gas phase oxygen concentration: 100 ppm), the mixture was heated to 76° C. with stirring under hermetically sealed conditions and polymerized at the same temperature for four hours. After heating to 120° C. to 130° C., unreacted monomers were removed at the same temperature under reduced pressure (0.027 to 0.040 MPa) over two hours. Further, the copolymer composition (B-1) obtained in Production Example 3 or the copolymer composition (B-2) obtained in Production Example 4 was added in an amount described in Table 3-1, Table 3-2, or Table 4. Thus, viscosity-index improving agents (R-1) to (R-28) and (S-1) to (S-4) were obtained. For each of the copolymers (A-1) to (A-18) and (A′-1) to (A′-3), the SP was calculated according to the above method, and the Mw and the Mn were measured according to the above methods. In addition, the solubility of the copolymer (A) in the base oil was evaluated according to the following method. Further, the oxidative stability of the viscosity-index improving agent was evaluated according to the following method. Further, the kinematic viscosity at 90° C. of the viscosity-index improving agent was measured according to the following method. Table 3-1, Table 3-2, and Table 4 show the results.

### <Method of Evaluating Solubility of Copolymer (A) in Base Oil>

The appearance of each of the viscosity-index improving agents (R-1) to (R-28) and (S-1) to (S-4) kept at a temperature of 25° C. for one day was visually observed under fluorescent white light at room temperature of 25° C., and the solubility of the copolymer (A) in the base oil was evaluated according to the following evaluation criteria.

### [Evaluation Criteria]

Good: The appearance is uniform without insoluble fractions of the copolymer.
Poor: The appearance is non-uniform, and insoluble fractions of the copolymer are observed.

### <Method of Measuring Oxidative Stability>

According to JIS-K2514, an oxidative stability test was performed at 165.5° C.±0.5° C. for 120 hours, and the amount of increase (mgKOH/g) in total acid value of the viscosity-index improving agent and the lubricating oil composition before and after the test was measured. A lower value indicates a better oxidative stability. [Evaluation criteria: viscosity-index improving agent]

Excellent: The amount of increase in total acid value of the lubricating oil composition before and after the test is not more than 30 mgKOH/g.
Good: The amount of increase in total acid value of the lubricating oil composition before and after the test is more than 30 mgKOH/g and not more than 50 mgKOH/g.
Fair: The amount of increase in total acid value of the lubricating oil composition before and after the test is more than 50 mgKOH/g and not more than 70 mgKOH/g.

### <Method of Measuring Kinematic Viscosity of Viscosity-Index Improving Agent>

The kinematic viscosity at 90° C. was measured according to the method described in JIS-K2283. A lower value indicates a lower viscosity and a better handleability.

TABLE 3-1

| | | Example | | | | | |
|---|---|---|---|---|---|---|---|
| | | 1 | 2 | 3 | 4 | 5 | 6 |
| Viscosity-index improving agent | | R-1 | R-2 | R-3 | R-4 | R-5 | R-6 |
| Copolymer | | A-1 | A-1 | A-1 | A-1 | A-1 | A-1 |
| Monomer | (a-1) | 7.5 | 7.5 | 7.5 | 7.5 | 7.5 | 7.5 |
| formulation | (a-2) | 7.5 | 7.5 | 7.5 | 7.5 | 7.5 | 7.5 |
| for producing | (b-1) | 60 | 60 | 60 | 60 | 60 | 60 |
| copolymer | (b-2) | — | — | — | — | — | — |
| (A) (wt %) | (c-1) | — | — | — | — | — | — |
| | (c-2) | 10 | 10 | 10 | 10 | 10 | 10 |
| | (d-1) | — | — | — | — | — | — |
| | (d-2) | — | — | — | — | — | — |
| | (e-1) | 10 | 10 | 10 | 10 | 10 | 10 |
| | (e-2) | 5 | 5 | 5 | 5 | 5 | 5 |
| | (e-3) | — | — | — | — | — | — |
| | (e-4) | — | — | — | — | — | — |
| | (e-5) | — | — | — | — | — | — |
| | (e-6) | — | — | — | — | — | — |
| | (e-7) | — | — | — | — | — | — |
| | (f-1) | — | — | — | — | — | — |
| | Total | 100 | 100 | 100 | 100 | 100 | 100 |
| Monomer formulation (parts by weight) | | 150 | 150 | 150 | 200 | 100 | 60 |
| Base oil (parts by weight) | | 342 | 350 | 342 | 292 | 392 | 432 |
| Catalyst | 2,2′-azobis | 0.11 | 0.11 | 0.11 | 0.11 | 0.11 | 0.11 |
| (parts by weight) | (2-methylbutyronitrile) | | | | | | |
| Copolymer composition (B-1) (parts by weight) | | 8 | 0 | 0 | 8 | 8 | 8 |
| Copolymer composition (B-2) (parts by weight) | | 0 | 0 | 8 | 0 | 0 | 0 |
| Amount in | Copolymer (A) | 30 | 30 | 30 | 40 | 20 | 12 |
| viscosity- | Copolymer (B) | 1 | 0 | 1 | 1 | 1 | 1 |
| index | Ester oil (Z-1) | 64.5 | 65.0 | 68.5 | 53.0 | 76.0 | 85.2 |
| improving | Ester oil (Z-2) | 0 | 0 | 0 | 0 | 0 | 0 |
| agent | Ester oil (Z-3) | 0 | 0 | 0 | 0 | 0 | 0 |
| (wt %) | Hydrocarbon oil 1 | 4.5 | 5.0 | 0.54 | 6.0 | 3.0 | 1.8 |
| | Hydrocarbon oil 2 | 0 | 0 | 0 | 0 | 0 | 0 |

| | | | | | | |
|---|---|---|---|---|---|---|
| Solubility of copolymer (A) in base oil | Good | Good | Good | Good | Good | Good |
| Oxidative stability | Excellent | Excellent | Fair | Excellent | Fair | Fair |
| Kinematic viscosity at 90° C. of | 3400 | 3300 | 3200 | 12000 | 600 | 300 |
| viscosity-index improving | | | | | | |
| agent (mm²/s) | | | | | | |
| SP of copolymer (A) | 9.20 | 9.20 | 9.20 | 9.20 | 9.20 | 9.20 |
| Mw (×10⁴) of copolymer (A) | 52 | 52 | 52 | 52 | 52 | 52 |
| Mw/Mn of copolymer (A) | 3.35 | 3.35 | 3.35 | 3.35 | 3.35 | 3.35 |
| Weight ratio ((A)/(Z)) | 32/68 | 32/68 | 30/70 | 43/57 | 21/79 | 12/88 |
| Weight ratio ((Z)/hydrocarbon oil) | 93/7 | 93/7 | 99/1 | 90/10 | 96/4 | 98/2 |
| Absolute difference between | 0.27 | 0.27 | 0.27 | 0.27 | 0.27 | 0.27 |
| SP of ester oil and SP of copolymer (A) | | | | | | |
| Weight ratio (c/b) | 0.17 | 0.17 | 0.17 | 0.17 | 0.17 | 0.17 |
| Weight ratio (d/b) | 0 | 0 | 0 | 0 | 0 | 0 |
| Weight ratio (c + d)/b | 0.17 | 0.17 | 0.17 | 0.17 | 0.17 | 0.17 |

| | | Example | | | |
|---|---|---|---|---|---|
| | | 7 | 8 | 9 | 10 |
| Viscosity-index improving agent | | R-7 | R-8 | R-9 | R-10 |
| Copolymer | | A-2 | A-3 | A-4 | A-5 |
| Monomer | (a-1) | 6 | 6 | 6.5 | 7.5 |
| formulation | (a-2) | 6 | 6 | 6.5 | 7.5 |
| for producing | (b-1) | 63 | 63 | 62 | 63 |
| copolymer | (b-2) | — | — | — | — |
| (A) (wt %) | (c-1) | — | — | — | — |
| | (c-2) | 18 | 15 | 15 | 16 |
| | (d-1) | — | — | — | — |
| | (d-2) | — | — | — | — |
| | (e-1) | 7 | 10 | 10 | 6 |
| | (e-2) | — | — | — | — |
| | (e-3) | — | — | — | — |
| | (e-4) | — | — | — | — |
| | (e-5) | — | — | — | — |
| | (e-6) | — | — | — | — |
| | (e-7) | — | — | — | — |
| | (f-1) | — | — | — | — |
| | Total | 100 | 100 | 100 | 100 |
| Monomer formulation (parts by weight) | | 150 | 150 | 150 | 150 |
| Base oil (parts by weight) | | 342 | 342 | 342 | 342 |
| Catalyst | 2,2′-azobis | 0.22 | 0.09 | 0.18 | 0.30 |
| (parts by weight) | (2-methylbutyronitrile) | | | | |
| Copolymer composition (B-1) (parts by weight) | | 8 | 8 | 8 | 8 |
| Copolymer composition (B-2) (parts by weight) | | 0 | 0 | 0 | 0 |
| Amount in | Copolymer (A) | 30 | 30 | 30 | 30 |
| viscosity- | Copolymer (B) | 1 | 1 | 1 | 1 |
| index | Ester oil (Z-1) | 65.4 | 65.4 | 34.5 | 34.5 |
| improving | Ester oil (Z-2) | 0 | 0 | 0 | 0 |
| agent | Ester oil (Z-3) | 0 | 0 | 0 | 0 |
| (wt %) | Hydrocarbon oil 1 | 3.6 | 3.6 | 34.5 | 34.5 |
| | Hydrocarbon oil 2 | 0 | 0 | 0 | 0 |

| | | | | |
|---|---|---|---|---|
| Solubility of copolymer (A) in base oil | Good | Good | Good | Good |
| Oxidative stability | Excellent | Excellent | Excellent | Excellent |
| Kinematic viscosity at 90° C. of | 2700 | 3500 | 4000 | 3000 |
| viscosity-index improving | | | | |
| agent (mm²/s) | | | | |
| SP of copolymer (A) | 9.28 | 9.26 | 9.25 | 9.25 |
| Mw (×10⁴) of copolymer (A) | 40 | 55 | 44 | 30 |
| Mw/Mn of copolymer (A) | 3.10 | 3.50 | 3.05 | 3.01 |
| Weight ratio ((A)/(Z)) | 31/69 | 31/69 | 47/53 | 47/53 |
| Weight ratio ((Z)/hydrocarbon oil) | 95/5 | 95/5 | 50/50 | 50/50 |
| Absolute difference between | 0.35 | 0.33 | 0.32 | 0.32 |
| SP of ester oil and SP of copolymer (A) | | | | |
| Weight ratio (c/b) | 0.29 | 0.24 | 0.24 | 0.25 |
| Weight ratio (d/b) | 0 | 0 | 0 | 0 |
| Weight ratio (c + d)/b | 0.29 | 0.24 | 0.24 | 0.25 |

TABLE 3-2

| | | Example | | | | | |
|---|---|---|---|---|---|---|---|
| | | 11 | 12 | 13 | 14 | 15 | 16 |
| Viscosity-index improving agent | | R-11 | R-12 | R-13 | R-14 | R-15 | R-16 |
| Copolymer | | A-6 | A-7 | A-7 | A-7 | A-7 | A-7 |
| Monomer | (a-1) | 7.5 | 6 | 6 | 6 | 6 | 6 |
| formulation | (a-2) | 7.5 | 6 | 6 | 6 | 6 | 6 |
| for producing | (b-1) | 63 | 42 | 42 | 42 | 42 | 42 |
| copolymer | (b-2) | — | — | — | — | — | — |
| (A) (wt %) | (c-1) | — | — | — | — | — | — |
| | (c-2) | 14 | 15 | 15 | 15 | 15 | 15 |
| | (d-1) | — | 21 | 21 | 21 | 21 | 21 |
| | (d-2) | — | — | — | — | — | — |
| | (e-1) | 8 | 10 | 10 | 10 | 10 | 10 |
| | (e-2) | — | — | — | — | — | — |
| | (e-3) | — | — | — | — | — | — |
| | (e-4) | — | — | — | — | — | — |
| | (e-5) | — | — | — | — | — | — |
| | (e-6) | — | — | — | — | — | — |
| | (e-7) | — | — | — | — | — | — |
| | (f-1) | — | — | — | — | — | — |
| | Total | 100 | 100 | 100 | 100 | 100 | 100 |
| Monomer formulation (parts by weight) | | 150 | 150 | 150 | 150 | 125 | 90 |
| Base oil (parts by weight) | | 342 | 350 | 342 | 342 | 367 | 402 |
| Catalyst | 2,2′-azobis | 0.29 | 0.32 | 0.32 | 0.32 | 0.32 | 0.32 |
| (parts by weight) | (2-methylbutyronitrile) | | | | | | |
| Copolymer composition (B-1) (parts by weight) | | 8 | 0 | 0 | 8 | 8 | 8 |
| Copolymer composition (B-2) (parts by weight) | | 0 | 0 | 8 | 0 | 0 | 0 |
| Amount in | Copolymer (A) | 30 | 30 | 30 | 30 | 25 | 18 |
| viscosity- | Copolymer (B) | 1 | 0 | 1 | 1 | 1 | 1 |
| index | Ester oil (Z-1) | 0 | 65.9 | 69.0 | 65.4 | 71.0 | 78.8 |
| improving | Ester oil (Z-2) | 34.4 | 0 | 0 | 0 | 0 | 0 |
| agent | Ester oil (Z-3) | 0 | 0 | 0 | 0 | 0 | 0 |
| (wt %) | Hydrocarbon oil 1 | 17.3 | 4.1 | 0.54 | 3.6 | 3.0 | 2.2 |
| | Hydrocarbon oil 2 | 17.3 | 0 | 0 | 0 | 0 | 0 |

| | | | | | | |
|---|---|---|---|---|---|---|
| Solubility of copolymer (A) in base oil | Good | Good | Good | Good | Good | Good |
| Oxidative stability | Excellent | Good | Fair | Excellent | Good | Fair |
| Kinematic viscosity at 90° C. of | 2300 | 1800 | 1800 | 1800 | 700 | 300 |
| viscosity-index improving agent | | | | | | |
| (mm²/s) | | | | | | |
| SP of copolymer (A) | 9.24 | 9.32 | 9.32 | 9.32 | 9.32 | 9.32 |
| Mw (×10⁴) of copolymer (A) | 31 | 28 | 28 | 28 | 28 | 28 |
| Mw/Mn of copolymer (A) | 2.94 | 3.05 | 3.05 | 3.05 | 3.05 | 3.05 |
| Weight ratio ((A)/(Z)) | 47/53 | 31/69 | 30/70 | 31/69 | 26/74 | 19/81 |
| Weight ratio ((Z)/hydrocarbon oil) | 50/50 | 94/6 | 99/1 | 95/5 | 96/4 | 97/3 |
| Absolute difference between | 0.37 | 0.39 | 0.39 | 0.39 | 0.39 | 9.32 |
| SP of ester oil and SP of copolymer (A) | | | | | | |
| Weight ratio (c/b) | 0.22 | 0.36 | 0.36 | 0.36 | 0.36 | 0.36 |
| Weight ratio (d/b) | 0 | 0.5 | 0.5 | 0.5 | 0.5 | 0.5 |
| Weight ratio (c + d)/b | 0.22 | 0.86 | 0.86 | 0.86 | 0.86 | 0.86 |

| | | Example | | | |
|---|---|---|---|---|---|
| | | 17 | 18 | 19 | 20 |
| Viscosity-index improving agent | | R-17 | R-18 | R-19 | R-20 |
| Copolymer | | A-7 | A-8 | A-9 | A-10 |
| Monomer | (a-1) | 6 | 15 | — | 7 |
| formulation | (a-2) | 6 | — | 14 | 7 |
| for producing | (b-1) | 42 | 58 | 36 | 50 |
| copolymer | (b-2) | — | — | — | — |
| (A) (wt %) | (c-1) | — | 15 | — | — |
| | (c-2) | 15 | — | 10 | 12 |
| | (d-1) | 21 | — | 30 | — |
| | (d-2) | — | — | — | — |
| | (e-1) | 10 | — | — | 10 |
| | (e-2) | — | — | — | — |
| | (e-3) | — | 7 | — | — |
| | (e-4) | — | 3 | — | — |
| | (e-5) | — | 2 | — | — |
| | (e-6) | — | — | 5 | — |
| | (e-7) | — | — | 5 | — |
| | (f-1) | — | — | — | 8 |
| | Total | 100 | 100 | 100 | 94 |
| Monomer formulation (parts by weight) | | 90 | 150 | 150 | 150 |
| Base oil (parts by weight) | | 402 | 342 | 342 | 342 |
| Catalyst | 2,2′-azobis | 0.065 | 0.26 | 0.30 | 0.29 |
| (parts by weight) | (2-methylbutyronitrile) | | | | |
| Copolymer composition (B-1) (parts by weight) | | 8 | 8 | 8 | 8 |
| Copolymer composition (B-2) (parts by weight) | | 0 | 0 | 0 | 0 |
| Amount in | Copolymer (A) | 18 | 30 | 30 | 30 |
| viscosity- | Copolymer (B) | 1 | 1 | 1 | 1 |
| index | Ester oil (Z-1) | 44.1 | 0 | 32.4 | 64.8 |
| improving | Ester oil (Z-2) | 34.7 | 64.5 | 0 | 0 |
| agent | Ester oil (Z-3) | 0 | 0 | 32.4 | 0 |
| (wt %) | Hydrocarbon oil 1 | 2.2 | 4.5 | 4.2 | 4.2 |
| | Hydrocarbon oil 2 | 0 | 0 | 0 | 0 |

| | | | | |
|---|---|---|---|---|
| Solubility of copolymer (A) in base oil | Good | Good | Good | Good |
| Oxidative stability | Fair | Excellent | Excellent | Excellent |
| Kinematic viscosity at 90° C. of | 700 | 2500 | 3000 | 2500 |
| viscosity-index improving agent | | | | |
| (mm²/s) | | | | |
| SP of copolymer (A) | 9.32 | 9.24 | 9.30 | 9.22 |
| Mw (×10⁴) of copolymer (A) | 70 | 35 | 30 | 31 |
| Mw/Mn of copolymer (A) | 3.75 | 3.17 | 2.90 | 2.98 |
| Weight ratio ((A)/(Z)) | 19/81 | 32/68 | 32/68 | 32/68 |
| Weight ratio ((Z)/hydrocarbon oil) | 97/3 | 93/7 | 94/6 | 94/6 |
| Absolute difference between | 5.39 | 0.31 | 4.86 | 9.22 |
| SP of ester oil and SP of copolymer (A) | | | | |
| Weight ratio (c/b) | 0.36 | 0.26 | 0.28 | 0.24 |
| Weight ratio (d/b) | 0.5 | 0 | 0.8 | 0 |
| Weight ratio (c + d)/b | 0.86 | 0.26 | 1.1 | 0.24 |

TABLE 4

| | | Example | | | | | |
|---|---|---|---|---|---|---|---|
| | | 21 | 22 | 23 | 24 | 25 | 26 |
| Viscosity-index improving agent | | R-21 | R-22 | R-23 | R-24 | R-25 | R-26 |
| Copolymer | | A-1 | A-12 | A-13 | A-14 | A-15 | A-16 |
| Monomer | (a-1) | 6 | 6 | 6 | 6 | 6 | 6 |
| formulation | (a-2) | 6 | 6 | 6 | 6 | 6 | 6 |
| for producing | (b-1) | 63 | 22.5 | 64.5 | 11.5 | 65.5 | 3.5 |
| copolymer | (b-2) | — | — | — | — | — | — |
| (A) (wt %) | (c-1) | — | 8 | — | 18 | — | — |
| | (c-2) | 3.5 | — | 2 | — | 1 | 21 |
| | (d-1) | — | 36 | — | 37 | — | 42 |
| | (d-2) | — | — | — | — | — | — |
| | (e-1) | 11 | 11 | 11 | 11 | 11 | 11 |
| | (e-2) | 10.5 | 10.5 | 10.5 | 10.5 | 10.5 | 10.5 |
| | (e-3) | — | — | — | — | — | — |
| | (e-4) | — | — | — | — | — | — |
| | (e-5) | — | — | — | — | — | — |
| | (e-6) | — | — | — | — | — | — |
| | (e-7) | — | — | — | — | — | — |
| | (f-1) | — | — | — | — | — | — |
| | Total | 100 | 100 | 100 | 100 | 100 | 100 |
| Monomer formulation (parts by weight) | | 150 | 150 | 150 | 150 | 150 | 150 |
| Base oil (parts by weight) | | 342 | 342 | 342 | 342 | 342 | 342 |
| Catalyst | 2,2′-azobis | 0.26 | 0.29 | 0.26 | 0.29 | 0.25 | 0.29 |
| (parts by weight) | (2-methylbutyronitrile) | | | | | | |
| Copolymer composition (B-1) (parts by weight) | | 8 | 8 | 8 | 8 | 8 | 8 |
| Copolymer composition (B-2) (parts by weight) | | 0 | 0 | 0 | 0 | 0 | 0 |
| Amount in | Copolymer (A) | 30 | 30 | 30 | 30 | 30 | 30 |
| viscosity- | Copolymer (B) | 1 | 1 | 1 | 1 | 1 | 1 |
| index | Ester oil (Z-1) | 65.4 | 65.4 | 65.4 | 65.4 | 65.4 | 65.4 |
| improving | Ester oil (Z-2) | 0 | 0 | 0 | 0 | 0 | 0 |
| agent | Ester oil (Z-3) | 0 | 0 | 0 | 0 | 0 | 0 |
| (wt %) | Hydrocarbon oil 1 | 3.6 | 3.6 | 3.6 | 3.6 | 3.6 | 3.6 |
| | Hydrocarbon oil 2 | 0 | 0 | 0 | 0 | 0 | 0 |

| | | | | | | |
|---|---|---|---|---|---|---|
| Solubility of copolymer (A) in base oil | Good | Good | Good | Good | Good | Good |
| Oxidative stability | Excellent | Excellent | Excellent | Excellent | Excellent | Excellent |
| Kinematic viscosity at 90° C. of | 2300 | 1800 | 2300 | 1700 | 2300 | 1800 |
| viscosity-index improving | | | | | | |
| agent (mm²/s) | | | | | | |
| SP of copolymer (A) | 9.21 | 9.32 | 9.21 | 9.34 | 9.21 | 9.32 |
| Mw (×10⁴) of copolymer (A) | 35 | 32 | 35 | 31 | 36 | 32 |
| Mw/Mn of copolymer (A) | 3.05 | 3.00 | 3.02 | 2.98 | 3.06 | 3.00 |
| Weight ratio ((A)/(Z)) | 31/69 | 31/69 | 31/69 | 31/69 | 31/69 | 31/69 |
| Weight ratio ((Z)/hydrocarbon oil) | 95/5 | 95/5 | 95/5 | 95/5 | 95/5 | 95/5 |
| Absolute difference between | 0.28 | 0.39 | 0.28 | 0.41 | 0.28 | 0.39 |
| SP of ester oil and SP of copolymer (A) | | | | | | |
| Weight ratio (c/b) | 0.06 | 0.36 | 0.03 | 1.57 | 0.02 | 6 |
| Weight ratio (d/b) | 0 | 1.6 | 0 | 3.2 | 0 | 12 |
| Weight ratio (c + d)/b | 0.056 | 2.0 | 0.031 | 4.8 | 0.015 | 18 |

| | | Example | | Comparative Example | | | |
|---|---|---|---|---|---|---|---|
| | | 27 | 28 | 1 | 2 | 3 | 4 |
| Viscosity-index improving agent | | R-27 | R-28 | S-1 | S-2 | S-3 | S-4 |
| Copolymer | | A-17 | A-18 | A′-1 | A′-2 | A′-3 | A-1 |
| Monomer | (a-1) | 7.5 | 7.5 | — | 6 | 6 | 7.5 |
| formulation | (a-2) | 7.5 | 7.5 | — | 6 | 6 | 7.5 |
| for producing | (b-1) | 50 | 50 | 50 | — | 66.5 | 60 |
| copolymer | (b-2) | — | 5 | — | — | — | — |
| (A) (wt %) | (c-1) | — | — | — | — | — | — |
| | (c-2) | 10 | 10 | 4 | 21 | — | 10 |
| | (d-1) | 5 | 5 | — | 45.5 | — | — |
| | (d-2) | 5 | — | — | — | — | — |
| | (e-1) | 10 | 10 | 25 | 11 | 11 | 10 |
| | (e-2) | 5 | 5 | 21 | 10.5 | 10.5 | 5 |
| | (e-3) | — | — | — | — | — | — |
| | (e-4) | — | — | — | — | — | — |
| | (e-5) | — | — | — | — | — | — |
| | (e-6) | — | — | — | — | — | — |
| | (e-7) | — | — | — | — | — | — |
| | (f-1) | — | — | — | — | — | — |
| | Total | 100 | 100 | 100 | 100 | 100 | 100 |
| Monomer formulation (parts by weight) | | 150 | 150 | 150 | 150 | 150 | 150 |
| Base oil (parts by weight) | | 342 | 342 | 342 | 342 | 342 | 342 |
| Catalyst | 2,2′-azobis | 0.11 | 0.11 | 0.11 | 0.29 | 0.25 | 0.11 |
| (parts by weight) | (2-methylbutyronitrile) | | | | | | |
| Copolymer composition (B-1) (parts by weight) | | 8 | 8 | 8 | 8 | 8 | 8 |
| Copolymer composition (B-2) (parts by weight) | | 0 | 0 | 0 | 0 | 0 | 0 |
| Amount in | Copolymer (A) | 30 | 30 | 30 | 30 | 30 | 30 |
| viscosity- | Copolymer (B) | 1 | 1 | 1 | 1 | 1 | 1 |
| index | Ester oil (Z-1) | 64.5 | 64.5 | 64.5 | 65.4 | 65.4 | 0 |
| improving | Ester oil (Z-2) | 0 | 0 | 0 | 0 | 0 | 0 |
| agent | Ester oil (Z-3) | 0 | 0 | 0 | 0 | 0 | 0 |
| (wt %) | Hydrocarbon oil 1 | 4.5 | 4.5 | 4.5 | 3.6 | 3.6 | 69 |
| | Hydrocarbon oil 2 | 0 | 0 | 0 | 0 | 0 | 0 |

| | | | | | | |
|---|---|---|---|---|---|---|
| Solubility of copolymer (A) in base oil | Good | Good | Good | Good | Good | Good |
| Oxidative stability | Excellent | Excellent | Fair | Fair | Excellent | Excellent |
| Kinematic viscosity at 90° C. of | 4200 | 4200 | 4300 | 3000 | 3000 | 52000 |
| viscosity-index improving | | | | | | |
| agent (mm²/s) | | | | | | |
| SP of copolymer (A) | 9.21 | 9.21 | 9.22 | 9.33 | 9.21 | 9.20 |
| Mw (×10⁴) of copolymer (A) | 52 | 52 | 52 | 32 | 36 | 52 |
| Mw/Mn of copolymer (A) | 3.35 | 3.35 | 2.90 | 2.98 | 3.00 | 3.30 |
| Weight ratio ((A)/(Z)) | 32/68 | 32/68 | 32/68 | 31/69 | 32/68 | — |
| Weight ratio ((Z)/hydrocarbon oil) | 93/7 | 93/7 | 93/7 | 95/5 | 95/5 | — |
| Absolute difference between | 0.28 | 0.28 | 0.29 | 0.40 | 0.28 | — |
| SP of ester oil and SP of copolymer (A) | | | | | | |
| Weight ratio (c/b) | 0.20 | 0.18 | 0.08 | — | 0 | 0.17 |
| Weight ratio (d/b) | 0.20 | 0.09 | 0 | — | 0 | 0 |
| Weight ratio (c + d)/b | 0.40 | 0.27 | 0.080 | — | 0 | 0.17 |

The base oils and the monomers (a) to (f) described in Table 3-1, Table 3-2, and Table 4 and the compositions of these base oils are as follows.
(a-1): Methacrylic acid ester [Mn: 6,600] of the hydrogenated polybutadiene polymer having a hydroxy group at one end (proportion of 1,2-butylene group=45 mol %) (Y-1) obtained in Production Example 1
(a-2): Methacrylic acid ester [Mn: 6,600] of the hydrogenated polybutadiene polymer having a hydroxy group at one end (proportion of 1,2-butylene group=65 mol %) (Y-2) obtained in Production Example 2
(b-1): n-Butyl methacrylate
(b-2): iso-Butyl methacrylate
(c-1): Ethoxyethyl methacrylate
(c-2): Butoxyethyl methacrylate
(d-1): Ethyl methacrylate
(d-2): Isopropyl methacrylate
(e-1): n-Dodecyl methacrylate (ester of methacrylic acid and Neodol25 (available from Shell Chemicals))
(e-2): C12-C13 straight-chain and branched alkyl methacrylate mixture (ester of methacrylic acid and Neodol23 (available from Shell Chemicals))
(e-3): C14-C15 straight-chain and branched alkyl methacrylate mixture (ester of methacrylic acid and Neodol45 (available from Shell Chemicals))
(e-4): n-Hexadecyl methacrylate
(e-5): n-Octadecyl methacrylate
(e-6): 2-n-Decyltetradecyl methacrylate
(e-7): 2-n-Dodecylhexadecyl methacrylate
(e-8): 2-n-Tetradecyloctadecyl methacrylate
(f-1): N,N-dimethylaminoethyl methacrylate Ester oil (Z-1): bis(2-ethylhexyl) adipate (SP: 8.93 (cal/cm³)^{1/2}; kinematic viscosity at 100° C.: 2.3 mm²/s; viscosity index: 118)
Ester oil (Z-2): bis(2-Ethylhexyl) sebacate (SP: 8.87 (cal/cm³)^{1/2}; kinematic viscosity at 100° C.: 3.2 mm²/s; viscosity index: 151)
Ester oil (Z-3): Diisodecyl adipate (SP: 8.97 (cal/cm³)^{1/2}; kinematic viscosity at 100° C.: 3.6 mm²/s; viscosity index: 141)
Hydrocarbon oil 1: SP: 8.3 to 8.4 (cal/cm³)^{1/2}; kinematic viscosity at 100° C.: 4.2 mm²/s; viscosity index: 122
Hydrocarbon oil 2: SP: 8.2 to 8.3 (cal/cm³)^{1/2}; kinematic viscosity at 100° C.: 3.1 mm²/s; viscosity index: 106

The results in Table 3-1, Table 3-2, and Table 4 show that the viscosity-index improving agents of the present invention have a low kinematic viscosity at 90° C. and an excellent handleability. The results show that the viscosity-index improving agents of the present invention have a lower viscosity and an excellent handleability because the viscosity-index improving agents each contain the ester oil and the copolymer (A) containing, as constituent monomers, the monomer (a), the monomer (b), and at least one of the monomer (c) and the monomer (d). Such results are particularly clear from comparisons between Example 1 and Comparative Example 1 not containing the monomer (a) as a constituent monomer but comparable to Example 1 in terms of Mw, base oil type, amount, and the like; between Example 26 and Comparative Example 2 not containing the monomer (b) as a constituent monomer but comparable to Example 26 in terms of Mw, base oil type, amount, and the like; between Example 25 and Comparative Example 3 not containing the monomer (c) and the monomer (d) as constituent monomers but comparable to Example 25 in terms of Mw, base oil type, amount, and the like; and between Example 1 and Comparative Example 4 not containing an ester oil but containing the same copolymer (A) as that in Example 1.

### Examples 29 to 56 and Comparative Examples 5 to 8: Evaluation of 0W-20

A stainless steel vessel equipped with a stirrer was charged with a hydrocarbon oil (SP: 8.3 to 8.4 (cal/cm³)^{1/2}; kinematic viscosity at 100° C.: 4.2 mm²/s; viscosity index: 128) (90 parts by weight) and a package additive “Infineum P5741” (base number: 84 mgKOH/g; calcium content: 2.49%; nitrogen content: 0.68%; phosphorus content: 0.78%; sulfated ash: 9.76%; zinc content: 0.86%) (10 parts by weight) to obtain lubricating oil compositions. Then, the viscosity-index improving agents (R-1) to (R-28) and (S-1) to (S-4) were added to the respective lubricating oil compositions such that each lubricating oil composition has a HTHS viscosity at 150° C. of 2.60+0.05 (mPa-s). Thus, lubricating oil compositions (V-1) to (V-28) and (W-1) to (W-4) were obtained.

The following properties of the lubricating oil compositions (V-1) to (V-28) and (W-1) to (W-4) were measured according to the following methods: shear stability (BOSCH SSI, Sonic SSI); HTHS viscosity (150° C., 100° C., 80° C.); kinematic viscosity (100° C., 40° C.); viscosity index; gelation index; low-temperature viscosity (−40° C.); evaporability at 250° C.; and oxidative stability. Table 5 and Table 6 show the results.

TABLE 5

| | | Example | | | | | | | |
|---|---|---|---|---|---|---|---|---|---|
| | | 29 | 30 | 31 | 32 | 33 | 34 | 35 | 36 |
| Lubricating oil composition | | V-1 | V-2 | V-3 | V-4 | V-5 | V-6 | V-7 | V-8 |
| Viscosity-index improving agent | | R-1 | R-2 | R-3 | R-4 | R-5 | R-6 | R-7 | R-8 |
| Amount of copolymer (A) | | 2.35 | 2.30 | 2.30 | 2.20 | 2.40 | 2.40 | 2.64 | 2.35 |
| in lubricating oil composition | | | | | | | | | |
| (wt %) | | | | | | | | | |
| Amount of copolymer (B) | | 0.08 | 0.00 | 0.08 | 0.06 | 0.12 | 0.20 | 0.09 | 0.08 |
| in lubricating oil composition | | | | | | | | | |
| (wt %) | | | | | | | | | |
| Amount of ester oil (Z) in | | 4.99 | 4.89 | 5.37 | 2.92 | 9.03 | 17.60 | 5.88 | 5.22 |
| lubricating oil composition | | | | | | | | | |
| (wt %) | | | | | | | | | |
| Amount of hydrocarbon oil | | 83.68 | 83.91 | 83.35 | 85.92 | 79.55 | 70.90 | 82.49 | 83.45 |
| in lubricating oil composition | | | | | | | | | |
| (wt %) | | | | | | | | | |
| Amount of additives | | 8.90 | 8.90 | 8.90 | 8.90 | 8.90 | 8.90 | 8.90 | 8.90 |
| in lubricating oil composition | | | | | | | | | |
| (wt %) | | | | | | | | | |
| Weight ratio (A/Z) | | 32/68 | 32/68 | 30/70 | 43/57 | 21/79 | 12/88 | 31/69 | 31/69 |
| Weight ratio | | 6/94 | 6/94 | 6/94 | 3/97 | 10/90 | 20/80 | 6/94 | 7/93 |
| (Z/hydrocarbon oil) | | | | | | | | | |
| Evaluation | HTHS viscosity | 2.6 | 2.6 | 2.6 | 2.6 | 2.6 | 2.6 | 2.6 | 2.6 |
| results | (150° C.) | | | | | | | | |
| | (mPa · s) | | | | | | | | |
| | HTHS viscosity | 4.55 | 4.55 | 4.54 | 4.57 | 4.51 | 4.49 | 4.49 | 4.44 |
| | (100° C.) | | | | | | | | |
| | (mPa · s) | | | | | | | | |
| | HTHS viscosity | 6.70 | 6.70 | 6.70 | 6.72 | 6.71 | 6.66 | 6.67 | 6.64 |
| | (80° C.) | | | | | | | | |
| | (mPa · s) | | | | | | | | |
| | Kinematic vicsosity | 7.31 | 7.30 | 7.31 | 7.35 | 7.25 | 7.20 | 6.90 | 6.96 |
| | at 100° C. | | | | | | | | |
| | (mm²/s) | | | | | | | | |
| | Kinematic vicsosity | 26.38 | 26.30 | 26.34 | 26.38 | 26.25 | 26.22 | 26.37 | 26.10 |
| | at 40° C. | | | | | | | | |
| | (mm²/s) | | | | | | | | |
| | Viscosity index | 266 | 267 | 267 | 269 | 264 | 262 | 242 | 249 |
| | BOSCH SSI (%) | 3 | 3 | 3 | 3 | 3.5 | 3.5 | 2 | 4 |
| | Sonic SSI (%) | 30 | 30 | 30 | 29 | 31 | 31 | 24 | 30 |
| | Low-temperature viscosity | 16,500 | 19,000 | 16,000 | 17,000 | 15,000 | 14,500 | 15,000 | 14,500 |
| | (−40° C.) | | | | | | | | |
| | (mPa · s) | | | | | | | | |
| | Gelation index | 4.8 | 5.0 | 4.9 | 5.2 | 4.7 | 4.7 | 4.4 | 4.2 |
| | Evaporability at 250° C. | 14.7 | 14.5 | 15.5 | 14.8 | 15.5 | 16.4 | 15.7 | 14.4 |
| | (%) | | | | | | | | |
| | Oxidative stability | Excellent | Excellent | Good | Excellent | Fair | Fair | Excellent | Excellent\| |

| | | Example | | | | | | |
|---|---|---|---|---|---|---|---|---|
| | | 37 | 38 | 39 | 40 | 41 | 42 | 43 |
| Lubricating oil composition | | V-9 | V-10 | V-11 | V-12 | V-13 | V-14 | V-15 |
| Viscosity-index improving agent | | R-9 | R-10 | R-11 | R-12 | R-13 | R-14 | R-15 |
| Amount of copolymer (A) | | 2.05 | 2.20 | 2.20 | 2.70 | 2.80 | 2.70 | 2.80 |
| in lubricating oil composition | | | | | | | | |
| (wt %) | | | | | | | | |
| Amount of copolymer (B) | | 0.07 | 0.07 | 0.07 | 0.00 | 0.09 | 0.09 | 0.11 |
| in lubricating oil composition | | | | | | | | |
| (wt %) | | | | | | | | |
| Amount of ester oil (Z) in | | 2.32 | 2.48 | 2.48 | 6.01 | 6.53 | 6.01 | 7.97 |
| lubricating oil composition | | | | | | | | |
| (wt %) | | | | | | | | |
| Amount of hydrocarbon oil | | 86.66 | 86.35 | 86.35 | 82.39 | 81.68 | 82.30 | 80.22 |
| in lubricating oil composition | | | | | | | | |
| (wt %) | | | | | | | | |
| Amount of additives | | 8.90 | 8.90 | 8.90 | 8.90 | 8.90 | 8.90 | 8.90 |
| in lubricating oil composition | | | | | | | | |
| (wt %) | | | | | | | | |
| Weight ratio (A/Z) | | 47/53 | 47/53 | 47/53 | 31/69 | 31/69 | 31/69 | 26/74 |
| Weight ratio | | 3/97 | 3/97 | 3/97 | 7/93 | 7/93 | 7/93 | 9/91 |
| (Z/hydrocarbon oil) | | | | | | | | |
| Evaluation | HTHS viscosity | 2.6 | 2.6 | 2.6 | 2.6 | 2.6 | 2.6 | 2.6 |
| results | (150° C.) | | | | | | | |
| | (mPa · s) | | | | | | | |
| | HTHS viscosity | 4.50 | 4.52 | 4.51 | 4.46 | 4.45 | 4.46 | 4.46 |
| | (100° C.) | | | | | | | |
| | (mPa · s) | | | | | | | |
| | HTHS viscosity | 6.71 | 6.68 | 6.70 | 6.66 | 6.65 | 6.65 | 6.66 |
| | (80° C.) | | | | | | | |
| | (mPa · s) | | | | | | | |
| | Kinematic vicsosity | 7.00 | 6.95 | 6.90 | 6.96 | 6.90 | 6.94 | 6.93 |
| | at 100° C. | | | | | | | |
| | (mm²/s) | | | | | | | |
| | Kinematic vicsosity | 26.50 | 26.53 | 26.54 | 26.50 | 26.44 | 26.50 | 26.49 |
| | at 40° C. | | | | | | | |
| | (mm²/s) | | | | | | | |
| | Viscosity index | 247 | 244 | 240 | 244 | 241 | 243 | 243 |
| | BOSCH SSI (%) | 2 | 1 | 1 | 1 | 1 | 1 | 1 |
| | Sonic SSI (%) | 26 | 20 | 21 | 17 | 17 | 16 | 17 |
| | Low-temperature viscosity | 20,000 | 19,000 | 18,000 | 17,000 | 14,500 | 14,500 | 14,000 |
| | (−40° C.) | | | | | | | |
| | (mPa · s) | | | | | | | |
| | Gelation index | 6.6 | 6.8 | 7.1 | 5.2 | 5.6 | 5.5 | 5.4 |
| | Evaporability at 250° C. | 14.3 | 14.3 | 13.5 | 15.1 | 15.0 | 15.0 | 15.4 |
| | (%) | | | | | | | |
| | Oxidative stability | Excellent | Excellent | Excellent | Excellent | Good | Excellent | Good |

TABLE 6

| | | Example | | | | | | | | |
|---|---|---|---|---|---|---|---|---|---|---|
| | | 44 | 45 | 46 | 47 | 48 | 49 | 50 | 51 | 52 |
| Lubricating oil composition | | V-16 | V-17 | V-18 | V-19 | V-20 | V-21 | V-22 | V-23 | V-24 |
| Viscosity-index improving agent | | R-16 | R-17 | R-18 | R-19 | R-20 | R-21 | R-22 | R-23 | R-24 |
| Amount of copolymer (A) | | 2.80 | 1.90 | 2.20 | 2.50 | 2.10 | 2.20 | 2.70 | 2.30 | 2.80 |
| in lubricating oil composition | | | | | | | | | | |
| (wt %) | | | | | | | | | | |
| Amount of copolymer (B) | | 0.16 | 0.11 | 0.07 | 0.08 | 0.07 | 0.07 | 0.09 | 0.08 | 0.09 |
| in lubricating oil composition | | | | | | | | | | |
| (wt %) | | | | | | | | | | |
| Amount of ester oil (Z) | | 11.94 | 8.10 | 4.68 | 5.31 | 4.46 | 4.90 | 6.01 | 5.12 | 6.23 |
| in lubricating oil composition | | | | | | | | | | |
| (wt %) | | | | | | | | | | |
| Amount of hydrocarbon oil | | 76.20 | 80.99 | 84.15 | 83.21 | 84.47 | 83.93 | 82.30 | 83.60 | 81.98 |
| in lubricating oil composition | | | | | | | | | | |
| (wt %) | | | | | | | | | | |
| Amount of additives | | 8.90 | 8.90 | 8.90 | 8.90 | 8.90 | 8.90 | 8.90 | 8.90 | 8.90 |
| in lubricating oil composition | | | | | | | | | | |
| (wt %) | | | | | | | | | | |
| Weight ratio (A/Z) | | 19/81 | 19/81 | 32/68 | 32/68 | 32/68 | 32/68 | 32/68 | 32/68 | 32/68 |
| Weight ratio | | 14/86 | 9/91 | 5/95 | 6/94 | 5/95 | 5/95 | 7/93 | 6/94 | 7/93 |
| (Z/hydrocarbon oil) | | | | | | | | | | |
| Evaluation | HTHS viscosity | 2.6 | 2.6 | 2.6 | 2.6 | 2.6 | 2.6 | 2.6 | 2.6 | 2.6 |
| results | (150° C.) | | | | | | | | | |
| | (mPa · s) | | | | | | | | | |
| | HTHS viscosity | 4.42 | 4.42 | 4.53 | 4.46 | 4.54 | 4.50 | 4.42 | 4.58 | 4.57 |
| | (100° C.) | | | | | | | | | |
| | (mPa · s) | | | | | | | | | |
| | HTHS viscosity | 6.64 | 6.64 | 6.70 | 6.67 | 6.71 | 6.70 | 6.65 | 6.75 | 6.76 |
| | (80° C.) | | | | | | | | | |
| | (mPa · s) | | | | | | | | | |
| | Kinematic vicsosity | 6.90 | 7.19 | 7.00 | 6.91 | 6.95 | 6.90 | 7.13 | 6.93 | 6.90 |
| | at 100° C. | | | | | | | | | |
| | (mm²/s) | | | | | | | | | |
| | Kinematic vicsosity | 26.30 | 26.44 | 26.51 | 26.45 | 26.39 | 26.34 | 26.29 | 26.61 | 26.84 |
| | at 40° C. | | | | | | | | | |
| | (mm²/s) | | | | | | | | | |
| | Viscosity index | 243 | 258 | 246 | 242 | 245 | 243 | 237 | 241 | 236 |
| | BOSCH SSI (%) | 1 | 5 | 2 | 1 | 1 | 3 | 4 | 2 | 1 |
| | Sonic SSI (%) | 17 | 37 | 19 | 18 | 17 | 23 | 36 | 18 | 15 |
| | Low-temperature viscosity | 13,000 | 15,500 | 15,000 | 14,500 | 14,000 | 19,500 | 18,500 | 19,000 | 22,000 |
| | (−40° C.) | | | | | | | | | |
| | (mPa · s) | | | | | | | | | |
| | Gelation index | 5.5 | 5.7 | 7.3 | 5.0 | 4.7 | 4.7 | 5.3 | 6.8 | 7.1 |
| | Evaporability at 250° C. | 15.9 | 14.2 | 12.9 | 13.7 | 14.4 | 14.7 | 15.2 | 15.0 | 15.3 |
| | (%) | | | | | | | | | |
| | Oxidative stability | Fair | Good | Excellent | Excellent | Excellent | Excellent | Excellent | Excellent | Excellent |

| | | Example | | | | Comparative Example | | | |
|---|---|---|---|---|---|---|---|---|---|
| | | 53 | 54 | 55 | 56 | 5 | 6 | 7 | 8 |
| Lubricating oil composition | | V-25 | V-26 | V-27 | V-28 | W-1 | W-2 | W-3 | W-4 |
| Viscosity-index improving agent | | R-25 | R-26 | R-27 | R-28 | S-1 | S-2 | S-3 | S-4 |
| Amount of copolymer (A) | | 2.20 | 2.90 | 2.30 | 2.30 | 3.96 | 2.90 | 2.20 | 2.30 |
| in lubricating oil composition | | | | | | | | | |
| (wt %) | | | | | | | | | |
| Amount of copolymer (B) | | 0.07 | 0.10 | 0.08 | 0.08 | 0.13 | 0.10 | 0.07 | 0.08 |
| in lubricating oil composition | | | | | | | | | |
| (wt %) | | | | | | | | | |
| Amount of ester oil (Z) | | 4.90 | 6.45 | 5.00 | 5.00 | 8.42 | 6.45 | 4.68 | 0.00 |
| in lubricating oil composition | | | | | | | | | |
| (wt %) | | | | | | | | | |
| Amount of hydrocarbon oil | | 83.93 | 81.65 | 83.72 | 83.72 | 78.59 | 81.65 | 84.15 | 88.72 |
| in lubricating oil composition | | | | | | | | | |
| (wt %) | | | | | | | | | |
| Amount of additives | | 8.90 | 8.90 | 8.90 | 8.90 | 8.90 | 8.90 | 8.90 | 8.90 |
| in lubricating oil composition | | | | | | | | | |
| (wt %) | | | | | | | | | |
| Weight ratio (A/Z) | | 32/68 | 32/68 | 32/68 | 32/68 | 32/68 | 32/68 | 32/68 | — |
| Weight ratio | | 5/95 | 7/93 | 7/93 | 7/93 | 10/90 | 7/93 | 5/95 | — |
| (Z/hydrocarbon oil) | | | | | | | | | |
| Evaluation | HTHS viscosity | 2.6 | 2.6 | 2.6 | 2.6 | 2.6 | 2.6 | 2.6 | 2.6 |
| results | (150° C.) | | | | | | | | |
| | (mPa · s) | | | | | | | | |
| | HTHS viscosity | 4.60 | 4.59 | 4.54 | 4.54 | 4.65 | 4.72 | 4.78 | 4.62 |
| | (100° C.) | | | | | | | | |
| | (mPa · s) | | | | | | | | |
| | HTHS viscosity | 6.78 | 6.79 | 6.69 | 6.69 | 6.85 | 6.84 | 6.86 | 6.94 |
| | (80° C.) | | | | | | | | |
| | (mPa · s) | | | | | | | | |
| | Kinematic vicsosity | 6.96 | 7.00 | 7.28 | 7.28 | 7.13 | 7.18 | 7.17 | 7.30 |
| | at 100° C. | | | | | | | | |
| | (mm²/s) | | | | | | | | |
| | Kinematic vicsosity | 27.03 | 27.08 | 26.30 | 26.30 | 27.56 | 29.30 | 29.50 | 27.35 |
| | at 40° C. | | | | | | | | |
| | (mm²/s) | | | | | | | | |
| | Viscosity index | 238 | 239 | 266 | 266 | 241 | 224 | 222 | 253 |
| | BOSCH SSI (%) | 2 | 1 | 3 | 3 | 25 | 6 | 3 | 3 |
| | Sonic SSI (%) | 22 | 21 | 30 | 30 | 49 | 38 | 27 | 31 |
| | Low-temperature viscosity | 20,000 | 23,500 | 16,500 | 16,500 | 51,000 | 27,000 | 22,500 | 23,000 |
| | (−40° C.) | | | | | | | | |
| | (mPa · s) | | | | | | | | |
| | Gelation index | 7.3 | 7.4 | 5.0 | 5.0 | 10.8 | 11.4 | 11.3 | 9.6 |
| | Evaporability at 250° C. | 14.9 | 15.5 | 14.7 | 14.7 | 16.5 | 16.3 | 15.5 | 12.5 |
| | (%) | | | | | | | | |
| | Oxidative stability | Excellent | Excellent | Excellent | Excellent | Fair | Good | Good | Excellent |

### Examples 57 to 84 and Comparative Examples 9 to 12: Evaluation of 0W-16

A stainless steel vessel equipped with a stirrer was charged with a hydrocarbon oil (SP: 8.3 to 8.4 (cal/cm³)^{1/2}; kinematic viscosity at 100° C.: 4.2 mm²/s; viscosity index: 128) (90 parts by weight) and a package additive “Infineum P57411” (10 parts by weight) to obtain lubricating oil compositions. Then, the viscosity-index improving agents (R-1) to (R-28) and (S-1) to (S-4) were added to the respective lubricating oil compositions such that each lubricating oil composition has a H-TH-S viscosity at 150° C. of 2.30±0.05 (mPa·s). Thus, lubricating oil compositions (V-29) to (V-56) and (W-5) to (W-8) were obtained. The following properties of the lubricating oil compositions (V-29) to (V-56) and (W-5) to (W-8) were measured according to the following methods: shear stability (BOSCH SSI, Sonic SSI); HTHS viscosity (150° C., 100° C., 80° C.); kinematic viscosity (100° C., 40° C.); viscosity index; gelation index; low-temperature viscosity (−40° C.); evaporability at 250° C.; and oxidative stability. Table 7 and Table 8 show the results.

TABLE 7

| | | Example | | | | | | | |
|---|---|---|---|---|---|---|---|---|---|
| | | 57 | 58 | 59 | 60 | 61 | 62 | 63 | 64 |
| Lubricating oil composition | | V-29 | V-30 | V-31 | V-32 | V-33 | V-34 | V-35 | V-36 |
| Viscosity-index improving agent | | R-1 | R-2 | R-3 | R-4 | R-5 | R-6 | R-7 | R-8 |
| Amount of copolymer (A) | | 1.56 | 1.60 | 1.60 | 1.50 | 1.70 | 1.70 | 1.80 | 1.60 |
| in lubricating oil composition | | | | | | | | | |
| (wt %) | | | | | | | | | |
| Amount of copolymer (B) | | 0.05 | 0.00 | 0.05 | 0.04 | 0.09 | 0.14 | 0.06 | 0.05 |
| in lubricating oil composition | | | | | | | | | |
| (wt %) | | | | | | | | | |
| Amount of ester oil (Z) | | 3.32 | 3.40 | 3.73 | 1.99 | 6.40 | 12.47 | 4.01 | 3.56 |
| in lubricating oil composition | | | | | | | | | |
| (wt %) | | | | | | | | | |
| Amount of hydrocarbon oil | | 86.17 | 86.10 | 85.72 | 87.57 | 82.91 | 76.79 | 85.23 | 85.89 |
| in lubricating oil composition | | | | | | | | | |
| (wt %) | | | | | | | | | |
| Amount of additives | | 8.90 | 8.90 | 8.90 | 8.90 | 8.90 | 8.90 | 8.90 | 8.90 |
| in lubricating oil composition | | | | | | | | | |
| (wt %) | | | | | | | | | |
| Weight ratio (A/Z) | | 32/68 | 32/68 | 30/70 | 43/57 | 21/79 | 12/88 | 31/69 | 31/69 |
| Weight ratio | | 4/96 | 4/96 | 4/96 | 2/98 | 7/93 | 14/86 | 5/95 | 4/96 |
| (Z/hydrocarbon oil) | | | | | | | | | |
| Evaluation | HTHS viscosity | 2.3 | 2.3 | 2.3 | 2.3 | 2.3 | 2.3 | 2.3 | 2.3 |
| results | (150° C.) | | | | | | | | |
| | (mPa · s) | | | | | | | | |
| | HTHS viscosity | 4.38 | 4.38 | 4.38 | 4.39 | 4.35 | 4.34 | 4.32 | 4.28 |
| | (100° C.) | | | | | | | | |
| | (mPa · s) | | | | | | | | |
| | HTHS viscosity | 6.45 | 6.45 | 6.45 | 6.46 | 6.42 | 6.41 | 6.43 | 6.40 |
| | (80° C.) | | | | | | | | |
| | (mPa · s) | | | | | | | | |
| | Kinematic vicsosity | 6.30 | 6.32 | 6.32 | 6.33 | 6.24 | 6.20 | 6.10 | 6.19 |
| | at 100° C. | | | | | | | | |
| | (mm²/s) | | | | | | | | |
| | Kinematic vicsosity | 24.89 | 24.95 | 24.85 | 24.90 | 24.83 | 24.80 | 24.88 | 24.62 |
| | at 40° C. | | | | | | | | |
| | (mm²/s) | | | | | | | | |
| | Viscosity index | 222 | 223 | 224 | 224 | 219 | 217 | 209 | 219 |
| | BOSCH SSI (%) | 2 | 2 | 2 | 2 | 2.5 | 2.5 | 2 | 3 |
| | Sonic SSI (%) | 28 | 28 | 29 | 26 | 30 | 30 | 22 | 28 |
| | Low-temperature viscosity | 15,000 | 17,000 | 14,500 | 15,000 | 13,500 | 13,000 | 14,000 | 13,000 |
| | (−40° C.) | | | | | | | | |
| | (mPa · s) | | | | | | | | |
| | Gelation index | 4.0 | 4.0 | 3.9 | 4.1 | 4.5 | 4.5 | 3.7 | 3.5 |
| | Evaporability at 250° C. | 14.4 | 14.2 | 15.3 | 14.5 | 16.2 | 15.5 | 14.1 | 14.0 |
| | (%) | | | | | | | | |
| | Oxidative stability | Excellent | Excellent | Good | Excellent | Good | Fair | Excellent | Excellent |

| | | Example | | | | | | |
|---|---|---|---|---|---|---|---|---|
| | | 65 | 66 | 67 | 68 | 69 | 70 | 71 |
| Lubricating oil composition | | V-37 | V-38 | V-39 | V-40 | V-41 | V-42 | V-43 |
| Viscosity-index improving agent | | R-9 | R-10 | R-11 | R-12 | R-13 | R-14 | R-15 |
| Amount of copolymer (A) | | 1.40 | 1.50 | 1.50 | 1.90 | 2.00 | 1.80 | 1.88 |
| in lubricating oil composition | | | | | | | | |
| (wt %) | | | | | | | | |
| Amount of copolymer (B) | | 0.05 | 0.05 | 0.05 | 0.00 | 0.07 | 0.06 | 0.08 |
| in lubricating oil composition | | | | | | | | |
| (wt %) | | | | | | | | |
| Amount of ester oil (Z) | | 1.58 | 1.69 | 1.69 | 4.23 | 4.67 | 4.01 | 5.34 |
| in lubricating oil composition | | | | | | | | |
| (wt %) | | | | | | | | |
| Amount of hydrocarbon oil | | 88.07 | 87.86 | 87.86 | 84.97 | 84.36 | 85.23 | 83.80 |
| in lubricating oil composition | | | | | | | | |
| (wt %) | | | | | | | | |
| Amount of additives | | 8.90 | 8.90 | 8.90 | 8.90 | 8.90 | 8.90 | 8.90 |
| in lubricating oil composition | | | | | | | | |
| (wt %) | | | | | | | | |
| Weight ratio (A/Z) | | 47/53 | 47/53 | 47/53 | 31/69 | 31/69 | 31/69 | 26/74 |
| Weight ratio | | 2/98 | 2/98 | 2/98 | 5/95 | 5/95 | 4/96 | 6/94 |
| (Z/hydrocarbon oil) | | | | | | | | |
| Evaluation | HTHS viscosity | 2.3 | 2.3 | 2.3 | 2.3 | 2.3 | 2.3 | 2.3 |
| results | (150° C.) | | | | | | | |
| | (mPa · s) | | | | | | | |
| | HTHS viscosity | 4.33 | 4.35 | 4.34 | 4.30 | 4.29 | 4.30 | 4.30 |
| | (100° C.) | | | | | | | |
| | (mPa · s) | | | | | | | |
| | HTHS viscosity | 6.46 | 6.44 | 6.45 | 6.42 | 6.41 | 6.43 | 6.42 |
| | (80° C.) | | | | | | | |
| | (mPa · s) | | | | | | | |
| | Kinematic vicsosity | 6.20 | 6.16 | 6.12 | 6.15 | 6.10 | 6.14 | 6.13 |
| | at 100° C. | | | | | | | |
| | (mm²/s) | | | | | | | |
| | Kinematic vicsosity | 25.00 | 25.03 | 25.04 | 25.00 | 25.00 | 25.01 | 24.99 |
| | at 40° C. | | | | | | | |
| | (mm²/s) | | | | | | | |
| | Viscosity index | 214 | 211 | 209 | 211 | 208 | 210 | 210 |
| | BOSCH SSI (%) | 2 | 1 | 1 | 1 | 1 | 1 | 1 |
| | Sonic SSI (%) | 24 | 18 | 20 | 16 | 17 | 16 | 16 |
| | Low-temperature viscosity | 18,000 | 17,500 | 17,000 | 14,500 | 13,500 | 14,000 | 12,500 |
| | (−40° C.) | | | | | | | |
| | (mPa · s) | | | | | | | |
| | Gelation index | 5.5 | 5.7 | 5.9 | 4.5 | 4.7 | 4.6 | 4.5 |
| | Evaporability at 250° C. | 14.1 | 13.2 | 14.8 | 14.4 | 14.8 | 14.7 | 15.1 |
| | (%) | | | | | | | |
| | Oxidative stability | Excellent | Excellent | Excellent | Excellent | Good | Excellent | Good |

TABLE 8

| | | Example | | | | | | | | |
|---|---|---|---|---|---|---|---|---|---|---|
| | | 72 | 73 | 74 | 75 | 76 | 77 | 78 | 79 | 80 |
| Lubricating oil composition | | V-44 | V-45 | V-46 | V-47 | V-48 | V-49 | V-50 | V-51 | V-52 |
| Viscosity-index improving agent | | R-16 | R-17 | R-18 | R-19 | R-20 | R-21 | R-22 | R-23 | R-24 |
| Amount of copolymer (A) | | 2.00 | 1.33 | 1.50 | 1.65 | 1.35 | 1.44 | 1.74 | 1.50 | 2.10 |
| in lubricating oil composition | | | | | | | | | | |
| (wt %) | | | | | | | | | | |
| Amount of copolymer (B) | | 0.11 | 0.07 | 0.05 | 0.06 | 0.05 | 0.05 | 0.06 | 0.05 | 0.07 |
| in lubricating oil composition | | | | | | | | | | |
| (wt %) | | | | | | | | | | |
| Amount of ester oil (Z) | | 8.53 | 5.68 | 3.19 | 3.51 | 2.87 | 3.21 | 3.87 | 3.34 | 4.67 |
| in lubricating oil composition | | | | | | | | | | |
| (wt %) | | | | | | | | | | |
| Amount of hydrocarbon oil | | 80.46 | 84.02 | 86.36 | 85.88 | 86.83 | 86.40 | 85.43 | 86.21 | 84.26 |
| in lubricating oil composition | | | | | | | | | | |
| (wt %) | | | | | | | | | | |
| Amount of additives | | 8.90 | 8.90 | 8.90 | 8.90 | 8.90 | 8.90 | 8.90 | 8.90 | 8.90 |
| in lubricating oil composition | | | | | | | | | | |
| (wt %) | | | | | | | | | | |
| Weight ratio (A/Z) | | 19/81 | 19/81 | 32/68 | 32/68 | 32/68 | 32/68 | 32/68 | 32/68 | 32/68 |
| Weight ratio | | 10/90 | 6/94 | 4/96 | 4/96 | 3/97 | 3/97 | 4/96 | 4/96 | 5/95 |
| (Z/hydrocarbon oil) | | | | | | | | | | |
| Evaluation | HTHS viscosity | 2.3 | 2.3 | 2.3 | 2.3 | 2.3 | 2.3 | 2.3 | 2.3 | 2.3 |
| results | (150° C.) | | | | | | | | | |
| | (mPa · s) | | | | | | | | | |
| | HTHS viscosity | 4.27 | 4.26 | 4.36 | 4.30 | 4.37 | 4.33 | 4.26 | 4.41 | 4.40 |
| | (100° C.) | | | | | | | | | |
| | (mPa · s) | | | | | | | | | |
| | HTHS viscosity | 6.41 | 6.40 | 6.45 | 6.43 | 6.46 | 6.45 | 6.41 | 6.50 | 6.51 |
| | (80° C.) | | | | | | | | | |
| | (mPa · s) | | | | | | | | | |
| | Kinematic vicsosity | 6.10 | 6.20 | 6.15 | 6.10 | 6.14 | 6.10 | 6.15 | 6.13 | 6.10 |
| | at 100° C. | | | | | | | | | |
| | (mm²/s) | | | | | | | | | |
| | Kinematic vicsosity | 24.90 | 24.94 | 25.01 | 24.95 | 24.90 | 24.85 | 24.80 | 25.10 | 25.32 |
| | at 40° C. | | | | | | | | | |
| | (mm²/s) | | | | | | | | | |
| | Viscosity index | 209 | 215 | 211 | 209 | 212 | 210 | 214 | 209 | 204 |
| | BOSCH SSI (%) | 1 | 4 | 1 | 1 | 1 | 2 | 3 | 1 | 1 |
| | Sonic SSI (%) | 17 | 35 | 18 | 16 | 16 | 21 | 33 | 16 | 14 |
| | Low-temperature viscosity | 12,000 | 14,500 | 14,000 | 13,000 | 13,000 | 17,500 | 17,000 | 17,000 | 20,000 |
| | (−40° C.) | | | | | | | | | |
| | (mPa · s) | | | | | | | | | |
| | Gelation index | 4.9 | 4.9 | 6.15 | 4.2 | 3.9 | 3.9 | 4.4 | 5.7 | 5.9 |
| | Evaporability at 250° C. | 15.7 | 14.0 | 12.7 | 13.5 | 14.1 | 14.5 | 15.0 | 14.7 | 15.0 |
| | (%) | | | | | | | | | |
| | Oxidative stability | Fair | Good | Excellent | Excellent | Excellent | Excellent | Excellent | Excellent | Excellent |

| | | Example | | | | Comparative Example | | | |
|---|---|---|---|---|---|---|---|---|---|
| | | 81 | 82 | 83 | 84 | 9 | 10 | 11 | 12 |
| Lubricating oil composition | | V-53 | V-54 | V-55 | V-56 | W-5 | W-6 | W-7 | W-8 |
| Viscosity-index improving agent | | R-25 | R-26 | R-27 | R-28 | S-1 | S-2 | S-3 | S-4 |
| Amount of copolymer (A) | | 1.50 | 2.00 | 1.60 | 1.60 | 2.70 | 2.00 | 1.50 | 2.10 |
| in lubricating oil composition | | | | | | | | | |
| (wt %) | | | | | | | | | |
| Amount of copolymer (B) | | 0.05 | 0.07 | 0.05 | 0.05 | 0.09 | 0.07 | 0.05 | 0.07 |
| in lubricating oil composition | | | | | | | | | |
| (wt %) | | | | | | | | | |
| Amount of ester oil (Z) | | 3.34 | 4.45 | 3.40 | 3.40 | 5.74 | 4.45 | 3.19 | 0.00 |
| in lubricating oil composition | | | | | | | | | |
| (wt %) | | | | | | | | | |
| Amount of hydrocarbon oil | | 86.21 | 84.58 | 86.05 | 86.05 | 82.57 | 84.58 | 86.36 | 88.93 |
| in lubricating oil composition | | | | | | | | | |
| (wt %) | | | | | | | | | |
| Amount of additives | | 8.90 | 8.90 | 8.90 | 8.90 | 8.90 | 8.90 | 8.90 | 8.90 |
| in lubricating oil composition | | | | | | | | | |
| (wt %) | | | | | | | | | |
| Weight ratio (A/Z) | | 32/68 | 32/68 | 32/68 | 32/68 | 32/68 | 32/68 | 32/68 | — |
| Weight ratio | | 4/96 | 5/95 | 4/96 | 4/96 | 7/93 | 5/95 | 4/96 | — |
| (Z/hydrocarbon oil) | | | | | | | | | |
| Evaluation | HTHS viscosity | 2.3 | 2.3 | 2.3 | 2.3 | 2.3 | 2.3 | 2.3 | 2.3 |
| results | (150° C.) | | | | | | | | |
| | (mPa · s) | | | | | | | | |
| | HTHS viscosity | 4.42 | 4.41 | 4.38 | 4.38 | 4.48 | 4.55 | 4.60 | 4.45 |
| | (100° C.) | | | | | | | | |
| | (mPa · s) | | | | | | | | |
| | HTHS viscosity | 6.53 | 6.54 | 6.45 | 6.45 | 6.60 | 6.59 | 6.61 | 6.69 |
| | (80° C.) | | | | | | | | |
| | (mPa · s) | | | | | | | | |
| | Kinematic vicsosity | 6.14 | 6.20 | 6.29 | 6.29 | 6.15 | 6.19 | 6.18 | 6.29 |
| | at 100° C. | | | | | | | | |
| | (mm²/s) | | | | | | | | |
| | Kinematic vicsosity | 25.50 | 25.55 | 24.90 | 24.90 | 26.00 | 28.00 | 28.00 | 25.80 |
| | at 40° C. | | | | | | | | |
| | (mm²/s) | | | | | | | | |
| | Viscosity index | 204 | 208 | 222 | 222 | 199 | 180 | 179 | 210 |
| | BOSCH SSI (%) | 2 | 1 | 2 | 2 | 20 | 5 | 2 | 2 |
| | Sonic SSI (%) | 21 | 19 | 28 | 28 | 45 | 35 | 25 | 27 |
| | Low-temperature viscosity | 18,000 | 21,000 | 15,000 | 15,000 | 42,000 | 24,000 | 20,000 | 21,000 |
| | (−40° C.) | | | | | | | | |
| | (mPa · s) | | | | | | | | |
| | Gelation index | 6.14 | 6.2 | 4.0 | 4.0 | 9.0 | 9.5 | 9.4 | 8.0 |
| | Evaporability at 250° C. | 14.7 | 15.2 | 14.4 | 14.4 | 16.3 | 16.0 | 15.3 | 12.3 |
| | (%) | | | | | | | | |
| | Oxidative stability | Excellent | Excellent | Excellent | Excellent | Fair | Good | Good | Excellent |

### <Method of Measuring H-TH-S Viscosity of Lubricating Oil Composition>

The H-TH-S viscosity was measured at 80° C., 100° C., and 150° C. according to the method of ASTM ID 4683. It is better when the HTHS viscosity at 80° C. and 100° C. is lower.

### <Method of Measuring Kinematic Viscosity and Method of Calculating Viscosity Index of Lubricating Oil Composition>

The kinematic viscosity at 40° C. and 100° C. was measured according to the method of JTS-K2283. The viscosity index was calculated according to the method of JTS-K2283. A higher viscosity index indicates a higher viscosity index improving effect.

### <Methods of Measuring and Calculating Shear Stability (BOSCH SSI) of Lubricating Oil Composition>

The shear stability was measured according to the method of ASTM D 6278 and calculated according to the method of ASTM D 6022. A lower value indicates a higher shear stability.

### <Methods of Measuring and Calculating Shear Stability (Sonic SSI) of Lubricating Oil Composition>

The shear stability was measured according to the method of JPI-5S-29-2006 and calculated according to the method of ASTM D 6022, using an ultrasonic shear device. A lower value indicates a higher shear stability.

### <Method of Measuring Low Temperature Viscosity of Lubricating Oil Composition>

The viscosity at −40° C. was measured according to the method of JPI-5S-42-2004. A lower value indicates a lower low-temperature viscosity.

### <Method of Measuring Gelation Index>

A scanning Brookfield viscometer was operated according to the method of ASTM D 5133 to measure the gelation index. Specifically, about 20 ml of the lubricating oil composition was poured into a glass stator to the fill line and pre-heated at 90° C. for 1.5 hours. Then, the temperature gradient program was set to cool from −5° C. to −40° C. at a scanning rate of 1° C./hour to measure the gelation index. A lower value indicates a better engine oil with a better low-temperature viscosity at low temperatures.

### <Method of Measuring Evaporability>

The evaporation rate at 250° C. was measured according to the method of ASTM D 5800. A smaller value indicates a better engine oil with a lower evaporation rate of the lubricating oil.

### <Method of Measuring Oxidative Stability>

According to JIS-K2514, an oxidative stability test was performed at 165.5° C.±0.5° C. for 120 hours, and the amount of increase (mgKOH/g) in total acid value of the viscosity-index improving agent and the lubricating oil composition before and after the test was measured. A lower value indicates a better oxidative stability.

### [Evaluation Criteria: Lubricating Oil Composition]

Excellent: The amount of increase in total acid value of the lubricating oil composition before and after the test is 3.0 mgKOH/g or lower.
Good: The amount of increase in total acid value of the lubricating oil composition before and after the test is more than 3.0 mgKOH/g and not more than 5.0 mgKOH/g.
Fair: The amount of increase in total acid value of the lubricating oil composition before and after the test is more than 5.0 mgKOH/g and not more than 7.0 mgKOH/g.

The results in Table 5 to Table 8 show that the lubricating oil compositions containing the viscosity-index improving agent of the present invention each have an appropriate gelation index, an excellent HTHS viscosity at 100° C., and excellent kinematic viscosity at 40° C., as well as an excellent viscosity index, an excellent shear stability, and an excellent low-temperature viscosity.

The lubricating oil composition of Comparative Examples 5 to 7 and 9 to 11 each contain one of the following viscosity-index improving agents: one containing the copolymer (A′) not containing the monomer (a) as a constituent monomer (Comparative Example 1); one containing the copolymer (A′) not containing the monomer (b) as a constituent monomer (Comparative Example 2); and one containing the copolymer (A′) not containing the monomer (c) or the monomer (d) as constituent monomers (Comparative Example 3).

Each of the lubricating oil compositions of Examples 29, 54, 53, 57, 82, and 81 contains the viscosity-index improving agent of Example 1, 26, or 25 containing the copolymer (A) which comprises, as constituent monomers, the monomer (a), the monomer (b), and at least one of the monomer (c) and the monomer (d), and has substantially the same SP and Mw as those of the copolymer in each of the lubricating oil compositions of Comparative Examples 5 to 7 and 9 to 11. The results show that the lubricating oil compositions of these Comparative Examples are inferior to the lubricating oil compositions of Examples 29, 54, 53, 57, 82, and 81, in terms of gelation index, HTHS viscosity at 100° C., and kinematic viscosity at 40° C. The results further show that the viscosity index, shear stability, low-temperature viscosity, oxidative stability, and evaporability at 250° C. are also poor in these comparative examples. The results also show that the lubricating oil compositions of Comparative Examples 8 and 12 containing the viscosity-index improving agent of Comparative Example 4 not containing an ester oil are inferior to the lubricating oil compositions of Examples 29 and 57 containing the same copolymer (A), in terms of gelation index, HTHS viscosity at 100° C., and kinematic viscosity at 40° C. The results further show that the viscosity index and low-temperature viscosity are also poor in these comparative examples.

### INDUSTRIAL APPLICABILITY

The lubricating oil compositions containing the viscosity-index improving agent of the present invention has an appropriate gelation index, an excellent HTHS viscosity at 100° C., and an excellent kinematic viscosity at 40° C. Thus, the lubricating oil compositions are suitable as gear oils (e.g., differential oil and industrial gear oil), MTF, transmission fluids (e.g., ATF, DCTF, and belt-CVTF), traction fluids (e.g., toroidal-CVTF), shock absorber fluids, power steering fluids, hydraulic oils (e.g., construction machinery hydraulic oil and industrial hydraulic oil), and engine oils (for gasoline and diesel).

1. A viscosity-index improving agent comprising:
a copolymer (A); and
an ester oil (Z),
the copolymer (A) containing, as constituent monomers, a polyolefin-based monomer (a) represented by the following formula (1), a monomer (b) represented by the following formula (2) in which R⁴ is a C4 alkyl group, and at least one of a monomer (c) represented by the following formula (3) and a monomer (d) represented by the following formula (2) in which R⁴ is a C2-C3 alkyl group: 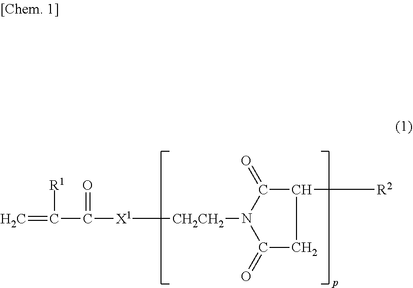
wherein R¹ is a hydrogen atom or a methyl group; —X¹— is a group represented by —O—, —O(AO)ₘ—, or —NH—, A is a C2-C4 alkylene group, m is an integer of 1 to 10, and each A may be the same or different when m is 2 or more; R² is a residue after removal of one hydrogen atom from a hydrocarbon polymer containing a 1,2-butylene group as a structural unit; and p represents a number of 0 or 1; 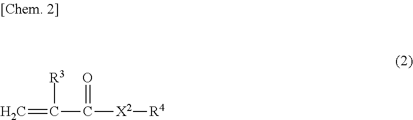
wherein R³ is a hydrogen atom or a methyl group; —X²— is a group represented by —O— or —NH—; and R⁴ is a C2-C4 alkyl group; 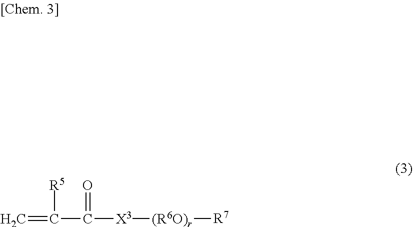
wherein R⁵ is a hydrogen atom or a methyl group; —X³— is a group represented by —O— or —NH—; R⁶ is a C2-C4 alkylene group; R⁷ is a C1-C8 alkyl group; and r is an integer of 1 to 20, and each R⁶ may be the same or different when r is 2 or more.

2. The viscosity-index improving agent according to claim 1,
wherein a weight ratio ((A)/(Z)) of the copolymer (A) to the ester oil (Z) in the viscosity-index improving agent is 10/90 to 70/30.

3. The viscosity-index improving agent according to claim 1,
wherein R² in the formula (1) is a residue after removal of one hydrogen atom from a hydrocarbon polymer containing a 1,2-butylene group and an isobutylene group as structural units, and the total proportion of the isobutylene group and the 1,2-butylene group based on the total number of moles of the structural units of the hydrocarbon polymer is 30 mol % or more.

4. The viscosity-index improving agent according to claim 1,
wherein a solubility parameter calculated based on weight fractions of the monomers constituting the copolymer (A) is 8.0 to 10.0 (cal/cm³)^{1/2}.

5. The viscosity-index improving agent according to claim 1,
wherein the ester oil has a kinematic viscosity at 100° C. of 1 to 4 mm²/s and a viscosity index of 100 or more.

6. The viscosity-index improving agent according to claim 1,
wherein a weight ratio {(c+d)/b} of the total weight of the monomer (c) and the monomer (d) to the weight of the monomer (b) among constituent monomers of the copolymer (A) is 0.01 to 20.

7. The viscosity-index improving agent according to claim 1,
wherein the copolymer (A) is a copolymer containing, as a constituent monomer, a (meth)acryloyl monomer (e) having a C9-C36 straight-chain or branched alkyl group.

8. The viscosity-index improving agent according to claim 7,
wherein the copolymer (A) is a copolymer containing, as constituent monomers, the monomer (a) in an amount of 1 to 50 wt %, the monomer (b) in an amount of 1 to 80 wt %, the monomer (c) and the monomer (d) in a total amount of 1 to 60 wt %, and the (meth)acryloyl monomer (e) in an amount of 1 to 60 wt % based on the total weight of the monomers constituting the copolymer (A).

9. The viscosity-index improving agent according to claim 1,
wherein the copolymer (A) has a weight average molecular weight of 5,000 to 2,000,000.

10. The viscosity-index improving agent according to claim 1,
wherein the viscosity-index improving agent contains a (meth)acrylic acid alkyl ester (co)polymer (B) different from the copolymer (A) in an amount of 0.01 to 30 wt % based on the weight of the copolymer (A).

11. The viscosity-index improving agent according to claim 1,
wherein an absolute difference between the solubility parameter of the copolymer (A) and the solubility parameter of the ester oil (Z) is 0.1 to 2.0 (cal/cm³)^{1/2}.

12. The viscosity-index improving agent according to claim 1, further containing a hydrocarbon oil.

13. A lubricating oil composition comprising:
the viscosity-index improving agent according to claim 1; and
at least one additive selected from the group consisting of a detergent, a dispersant, an antioxidant, an oiliness improver, a pour point depressant, a friction and wear modifier, an extreme pressure agent, a defoamer, a demulsifier, a metal deactivator, and a corrosion inhibitor.
